(19) United States
(12) Patent Application Publication
(10) Pub. No.: US 2016/0034914 A1
(43) Pub. Date: Feb. 4, 2016

(54) PROCESS FOR CROWD-SOURCED COMPLETION OF INVESTIGATIVE TASKS

(71) Applicant: YPB Group Ltd., Sydney NSW (AU)

(72) Inventors: David Gonen, Calabasas, CA (US); Jonathan A. Gonen, Calabasas, CA (US); Shlomo Gonen, Calabasas, CA (US)

(73) Assignee: YPB Group Ltd

(21) Appl. No.: 14/811,030

(22) Filed: Jul. 28, 2015

Related U.S. Application Data
(60) Provisional application No. 62/030,141, filed on Jul. 29, 2014.
(60) Provisional application No. 62/130,360, filed on Mar. 9, 2015.

(51) Int. Cl. G06Q 30/00; G06Q 30/02; G06Q 50/00

(52) U.S. Cl. CPC G06Q 30/0185; G06Q 50/01; G06Q 30/0208

(57) ABSTRACT

A process for crowd-sourced completion of one or more investigative tasks may be utilized by intellectual property (IP) rights holders to identify trends in the infringement of intellectual property rights. As such, the inventive process may be utilized as a mobile trademark monitoring system. The process includes the steps of registering a plurality of users in a database on a centralized platform, and providing a software application to each of the users. The software application generates a report including information pertaining to the investigative task. A system server receives separate reports from two or more of the users and the reports are analyzed to identify trends.

### RELATED APPLICATIONS

This application claims the benefit of U.S. Provisional Application No. 62/130,360, filed on Mar. 9, 2015; this application also claims the benefit of U.S. Provisional Application No. 62/030,141, filed Jul. 29, 2014.

### FIELD OF THE INVENTION

The present invention generally relates to a system for tracking and reporting infringement of trademarks and other types of intellectual property.

### BACKGROUND OF THE INVENTION

Crowd sourcing is a method for outsourcing tasks to a distributed group of people. Crowd sourcing has been used to find solutions to engineering problems, translate books, and even locate runaways. In crowd sourcing, the “sourcer” advertises the needed task, and the “crowd” works on the task until it is completed. The sourcer may pay the crowd for completed tasks, or award points to the crowd in a rewards program. Crowd sourcing has become an easy way to spread a large task among many people. Recently, sourcers have started using crowd sourcing as a way to protect their intellectual property.

Intellectual property infringement is a growing global problem; especially in the consumer goods market. High demand turns luxury and brand name goods into a target for counterfeiters. Many types of consumer goods, such as designer clothing, luxury goods, and even perfumes, are easily counterfeited using inferior materials. These inferior “knock-offs” are then flooded into the market at a steeply reduced price. Some naïve consumers believe they are getting a deal, while other more savvy shoppers are content to purchase a look-a-like for a fraction of the cost.

The counterfeit market effects more than clothes, watches, and handbags. Counterfeit products have been found among DVDs, consumer electronics, aircraft components and car parts, pharmaceuticals, and even food. This is particularly problematic in that people can be seriously hurt by using or consuming these types of fraudulent goods. Consumer fraud also exists online in the form of fake websites, scams, and internet trafficking of knock-off goods. Not only can counterfeits be dangerous to an unwary consumer, they can also do serious damage to the genuine brand on which the knock-off is based. Companies may expend time and resources in establishing their brand among the consuming public only to lose customer loyalty because of one or more counterfeits.

Counterfeiting, in all its forms, has become a trillion dollar global industry. Brand owners with trademarks, copyrights, trade dress rights, and so on, suffer untold amounts of monetary damages each year from the loss of sales resulting from these counterfeit goods, product diversions, and other intellectual property and brand abuse. In response to this growing problem, state and federal task forces work to take counterfeit goods off the market. Companies like MARK MONITOR® have also been set up to head off fraud on the internet. A problem exists, however, in that these efforts rarely trace back to the manufacturing source of the fraud. This means that the counterfeit goods never really stop being produced. Additionally, vast quantities of fraudulent products are sold in back streets and side alleys as part of mobile operations that are easily relocated. Areas such as New York's Canal Street and Los Angeles' Santee Alley are common in most of the world's urban centers. And while law enforcement officials frequent these locations in an effort to seize counterfeit goods, the flood really cannot be stemmed until the manufacturing source is shut down.

State and federal agencies simply do not have the resources needed to police the manufacture and sale of counterfeit goods. In light of this, a solution is needed that will allow intellectual property owners to more effectively monitor their property. Ideally, the most effective way for a brand owner to police the use of its intellectual property would be to enlist the help of its purchasing public via crowd sourcing. Unfortunately the speed and mobility of the counterfeit market has heretofore made such a proposition impossible. There is no easy way for a brand owner to communicate with its purchasers this need for help. Likewise, there was no way for the purchasing public to quickly and accurately report the sale of fraudulent items.

Thus, there is a need to provide intellectual property owners with a way to quickly and effectively communicate their policing needs to their brand purchasers so as to crowd source the policing. Likewise, there is a need for a way for the brand purchasers to quickly and easily report counterfeit goods to the brand owner. The present invention fulfills these needs and provides other related advantages.

### SUMMARY OF THE INVENTION

The present invention relates to a process for crowd-sourced completion of one or more investigative tasks. The process involves registering a plurality of users in a database on a centralized platform. The users are each provided a software application that generates a report including information pertaining to the one or more investigative tasks. Separate reports related to the one or more investigative tasks as received from two or more of the users on a system server. The separate reports are uploaded from the system server to the database on the centralized platform. Multiple received reports related to a single investigative task are reviewed and analyzed to identify trends.

The investigative task may relate to investigation of intellectual property (“IP”) rights held by a rights owner. In this case, the report includes identification of the IP rights, the rights owner, a known or suspected infringement of the IP rights, and a location of the known or suspected infringement. The investigative task preferably relates to infringement of the IP rights. Where infringement of IP rights is involved, the trends identified in the multiple received reports relate to the IP rights, the rights owner, an identifiable source of infringement, particular commercial products, consumer price points, or a location. The process may also include forwarding the multiple received reports related to the single investigative task to the rights owner along with the analysis of the same. The particular IP rights may include patents, trademarks, copyrights, brand names, identity rights, publicity rights, music rights, jingle rights, artwork, photographs, or royalty reporting.

The process may also include transmitting information regarding genuine IP rights from the rights owner to the users through the software application, including assigning a specific research task for particular IP rights to the users relating to the genuine IP rights information. The process may also include transmitting information about known or suspected infringement of the IP rights from the rights owner to the users through the software application, including assigning a specific research task for particular IP rights to the users relating to the known or suspected infringement of the IP rights.

The software application is preferably installed on a mobile computing device, but may be usable on any computing device, e.g., desktop, server, web-based, etc. The information pertaining to the one or more investigative tasks preferably includes location, identification, and results of the one or more investigative tasks. The location should include specification of geolocation, residential location, or business location. The identification should include specification by list, category, photograph, or audio/video recording of the subjects of the one or more investigative tasks. The audio/video recording preferably includes a listen feature whereby the software application matches the audio/video recording to a similar known recording.

The users may be incentivized to perform the one or more investigative tasks, including by a cash reward, a prize bounty, or a game score, e.g., social score or ranking. The incentives are preferably tiered based upon a user rating. The prize bounty may include an online commerce opportunity or an offline commerce opportunity related to the one or more investigative tasks. The offline commerce opportunity may use geolocation retail proximity to offer discount or coupon codes usable in a retail location. Each of the users may be rated based upon the analysis of the reviewed reports. The analysis of the received reports uses an algorithm that considers the users' reporting histories, the users' reporting reliability, a social graph for the users, crowd source reviews, and brand review history.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a screen shot where the user is instructed to add a tip regarding a counterfeit report;

FIG. 1A is a screen shot where the user scans a suspected counterfeit product's bar code;

FIG. 2 is a screen shot where the user can allow his mobile phone to track his location via GPS;

FIG. 3 is a screen shot illustrating the user's ability to manually input his location;

FIG. 4 is a screen shot illustrating the user's ability to associate photographs of the allegedly counterfeit with the report;

FIG. 5 is a screen shot illustrating the user's ability to delete photographs out of the report;

FIG. 6 is a screen shot of the report with no information associated with it;

FIG. 7 is a screen shot of the brand search within the mobile application;

FIG. 8 is a screen shot of the brand search illustrating the user's ability to type in search terms;

FIG. 9 is a screen shot of the brand search illustrating the ability to filter out brands as a search term is being typed;

FIG. 10 is a screen shot illustrating the user's ability to pick a brand once the correct brand has been found;

FIG. 11 is a screen shot illustrating the category search within the mobile application featuring an assortment of categories;

FIG. 12 is a screen shot illustrating the ability to add a comment to a picture of a counterfeit product;

FIG. 13 is a screen shot illustrating instructions issued to the user of the mobile application on how to create a photograph comment;

FIG. 14 is a screen shot of the dialog box where the user can add his comments to a photograph;

FIG. 15 is a screen shot illustrating the ability to add extra information to the comments section of a report;

FIG. 16 is a screen shot illustrating a photograph that has be commented on;

FIG. 17 is a screen shot of the report with multiple photographs that have been commented on, selected categories and brands, and a location;

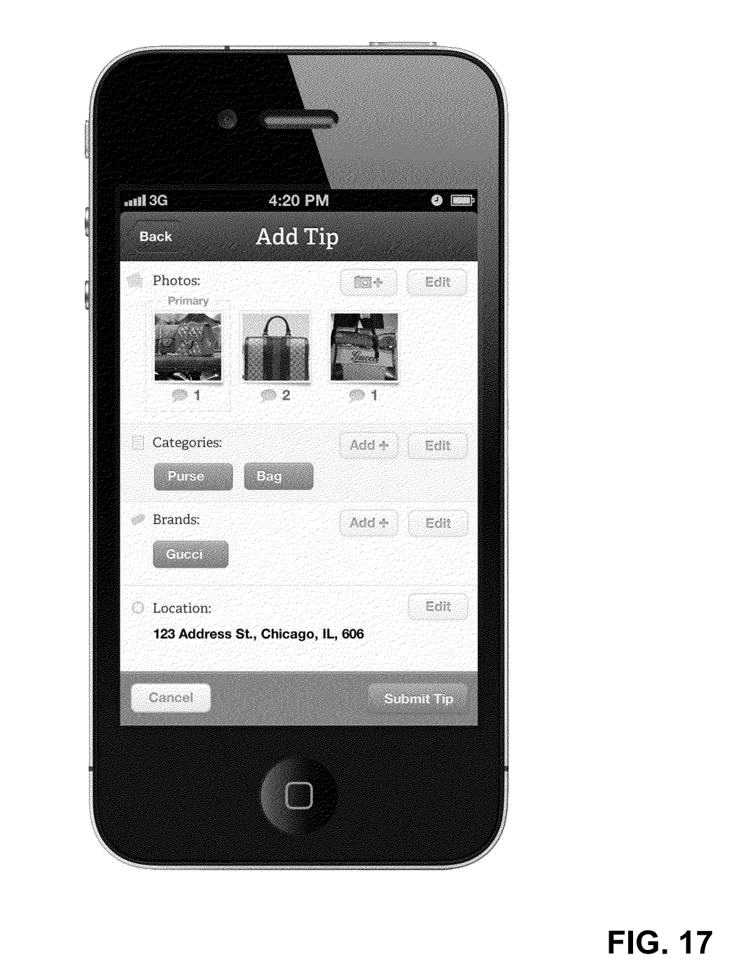

FIG. 18 is a screen shot showing that photographs can be deleted from a report;

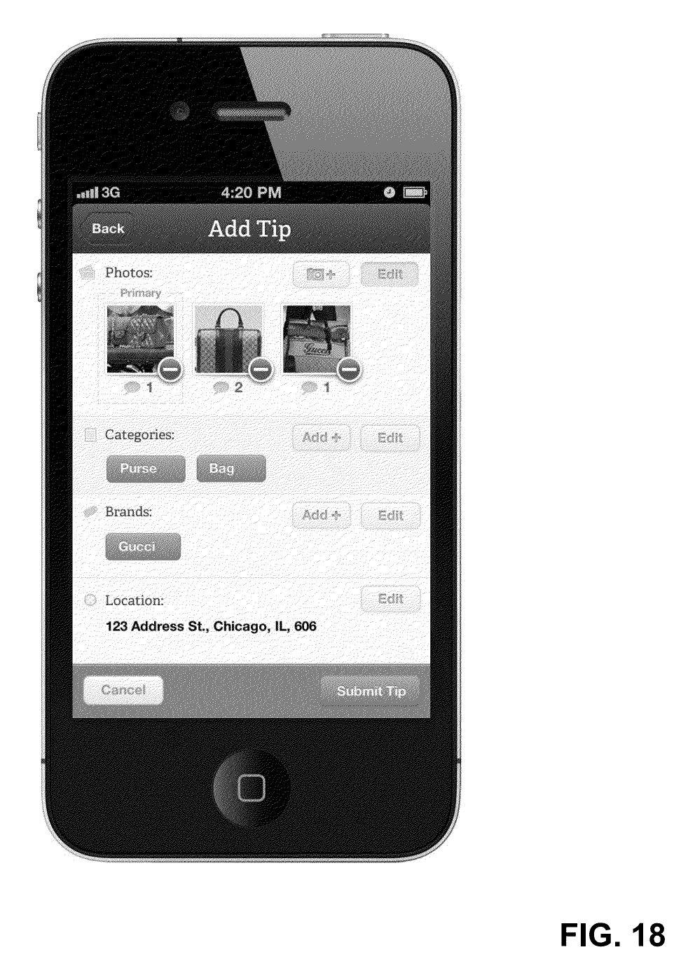

FIG. 19 is a screen shot illustrating an action confirmation in the mobile application;

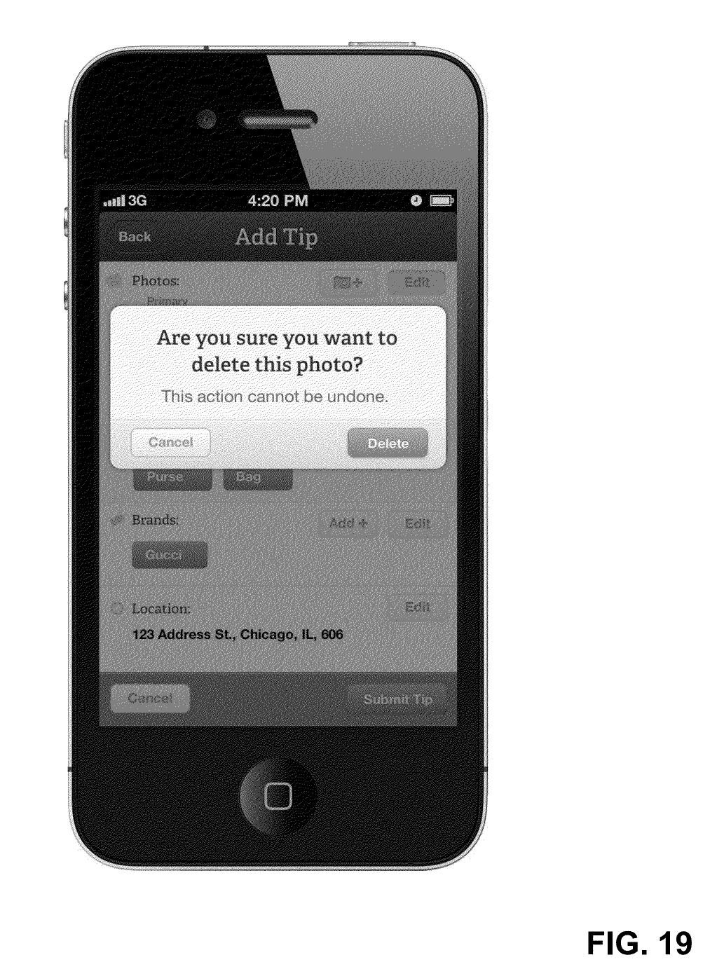

FIG. 20 is a screen shot of the report after the photographs have been deleted;

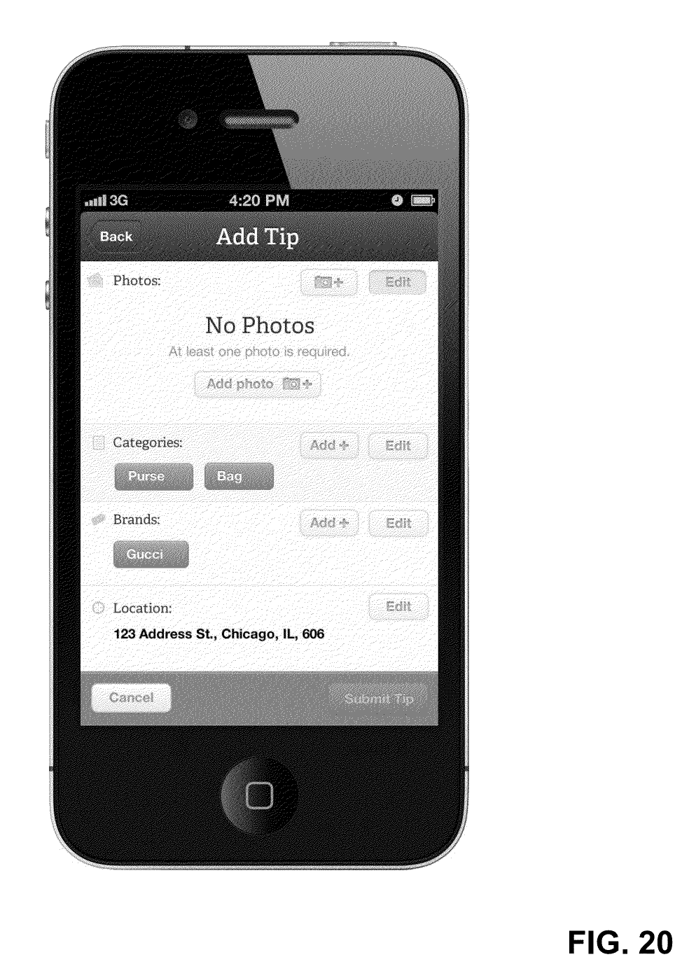

FIG. 21 is a screen shot showing that the other areas of the report can also be edited;

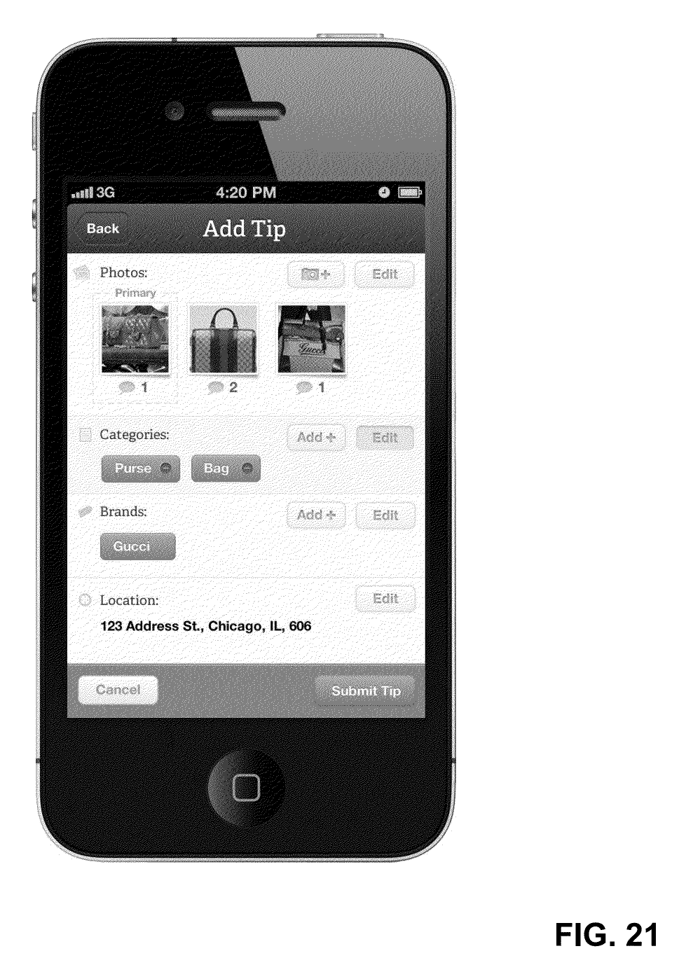

FIG. 22 is a screen shot of the welcome screen of the mobile application illustrating that a report can be created by a registered user, a first time user, or an anonymous tipster;

FIG. 23 is a screen shot of the log in screen of the mobile application illustrating the information necessary to log into the application;

FIG. 24 is a screen shot of the mobile application upon successful submission of a report illustrating a view of other submitted tips that are either verified or un-verified;

FIG. 25 is a screen shot of a title screen from an alternate embodiment of the mobile application;

FIG. 26 is a screen shot of an account registration screen from the alternate embodiment of the mobile application;

FIG. 27 is a screen shot of an activity record screen from the alternate embodiment of the mobile application;

FIG. 28 is a screen shot of a photo capture screen from the alternate embodiment of the mobile application;

FIG. 29 is a screen shot of a reporting screen from the alternate embodiment of the mobile application;

FIG. 30 is a screen shot of a reporting location screen from the alternate embodiment of the mobile application;

FIG. 31 is a screen shot of a reporting product classification screen from the alternate embodiment of the mobile application;

FIG. 32 is a screen shot of a reporting quantity screen from the alternate embodiment of the mobile application;

FIG. 33 is a screen shot of a reporting price screen from the alternate embodiment of the mobile application;

FIG. 34 is a screen shot of a reporting sample screen from the alternate embodiment of the mobile application;

FIG. 35 is a screen shot of a reporting photo screen from the alternate embodiment of the mobile application;

FIG. 36 is a screen shot of a report photo tagging screen from the alternate embodiment of the mobile application;

FIG. 37 is a screen shot of a report photo tagging screen from the alternate embodiment of the mobile application;

FIG. 38 is a screen shot of an updated activity screen from the alternate embodiment of the mobile application; and

FIG. 39 is a screen shot of a knowledge library screen from the alternate embodiment of the mobile application.

### DETAILED DESCRIPTION OF THE PREFERRED EMBODIMENTS

The present system is directed at providing effective automated methods for facilitating crowd sourcing in various fields.

The method of crowd sourcing described herein has application for research and/or investigation in a number of diverse areas for: (i) intellectual property infringement; (ii) counterfeit products; (iii) technological/intellectual property validity and/or invalidity; and/or (iv) any other type of investigation and/or research where crowd sourcing would provide benefits. The inventive method could be used for reporting/receiving tips and tasks originating from a mobile web browser, a downloadable mobile application, or an electronic messaging service employing computer servers, i.e., email, SMS, etc.

Individuals providing research and/or investigation services through the inventive method would be rewarded, whether monetarily or through other means. Monetary rewards may be one-time or profit sharing. Other means of reward may include non-monetary prizes such as prizes or social media “gifts”, i.e., increased status, points, badges, etc. A research or investigation task may even be part of a contest or lottery subject to its own rules and prizes as determined by a sponsor. Participating in a research or investigation task under the inventive method may entitle a participant to one or more entries in a contest or lottery.

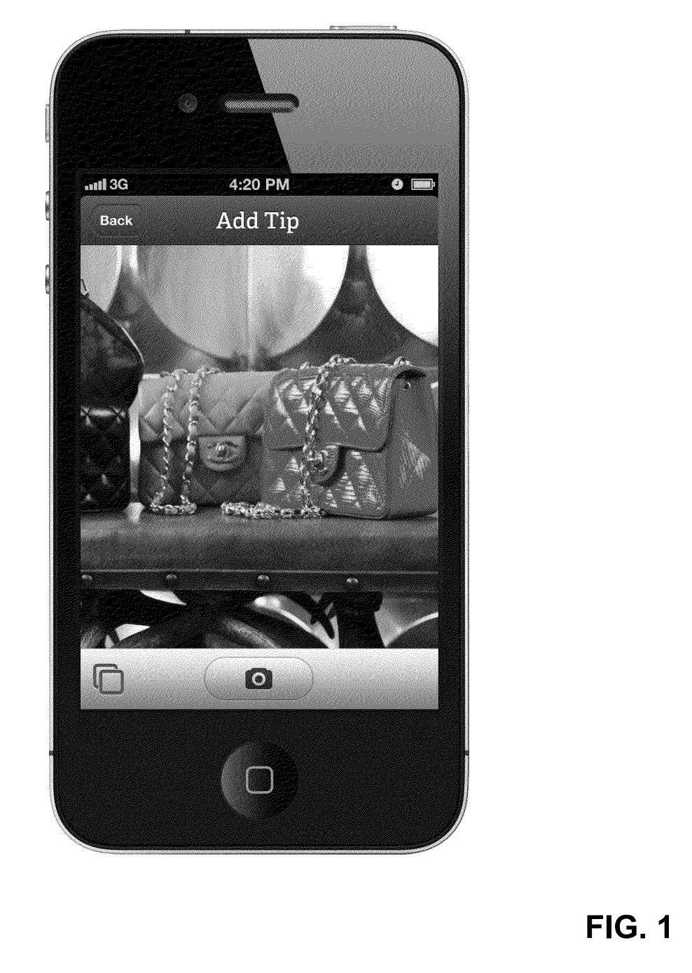

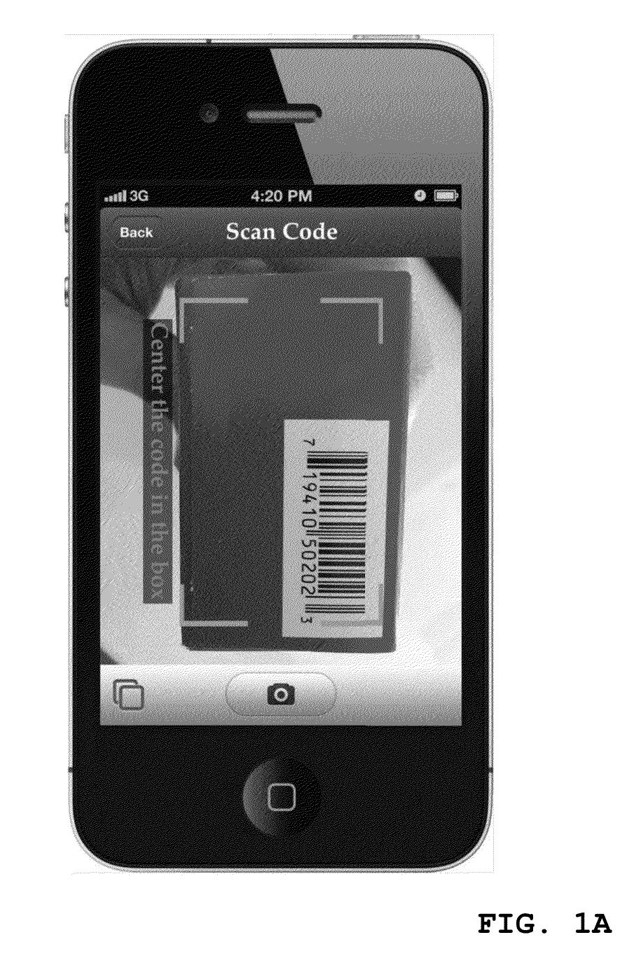

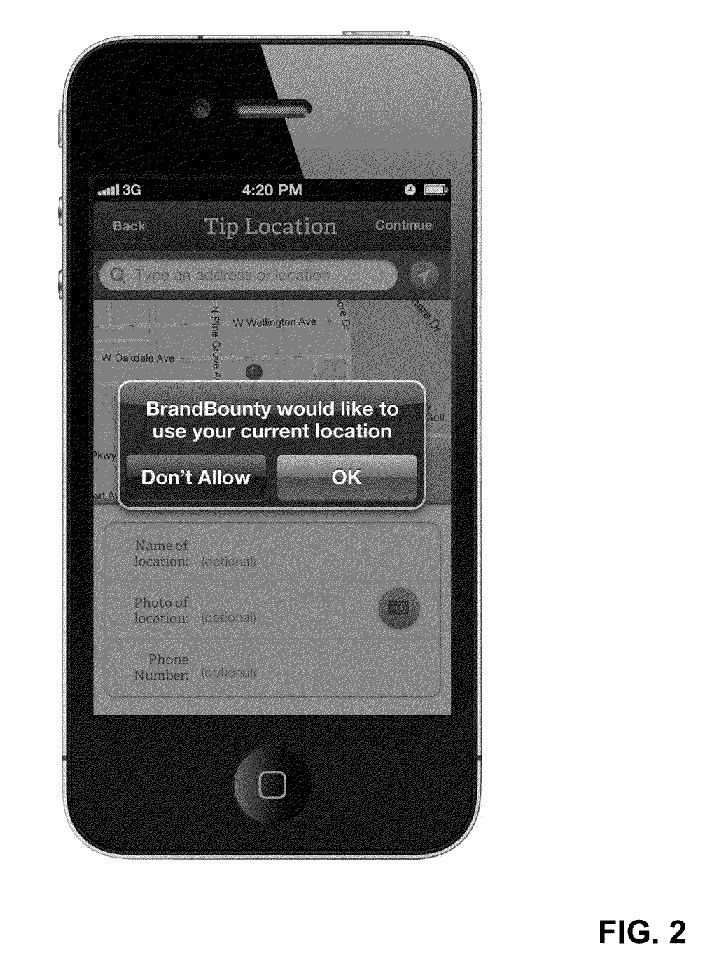

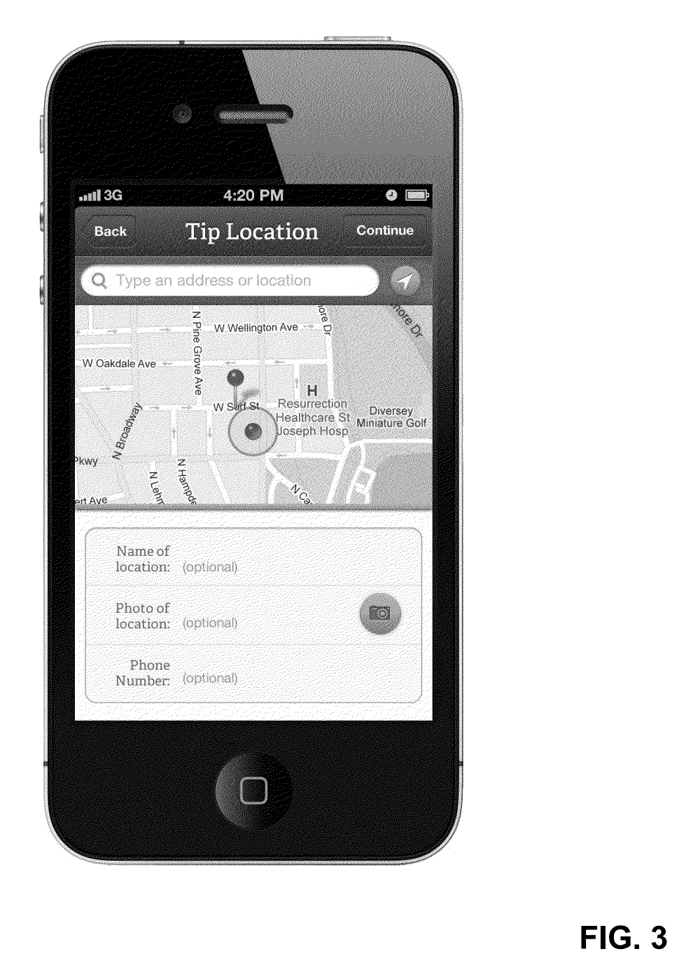

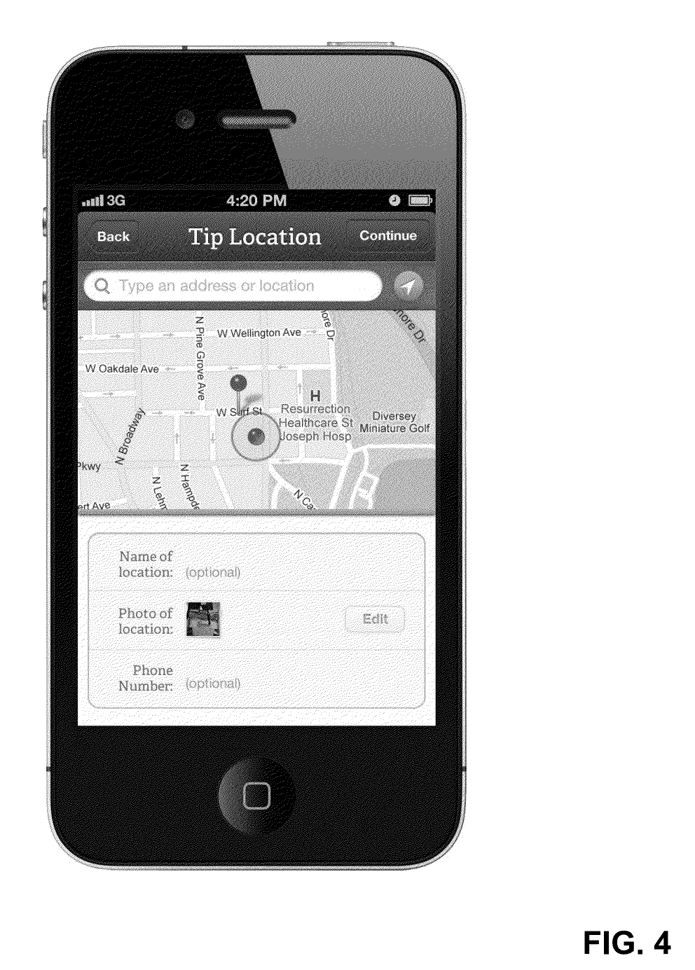

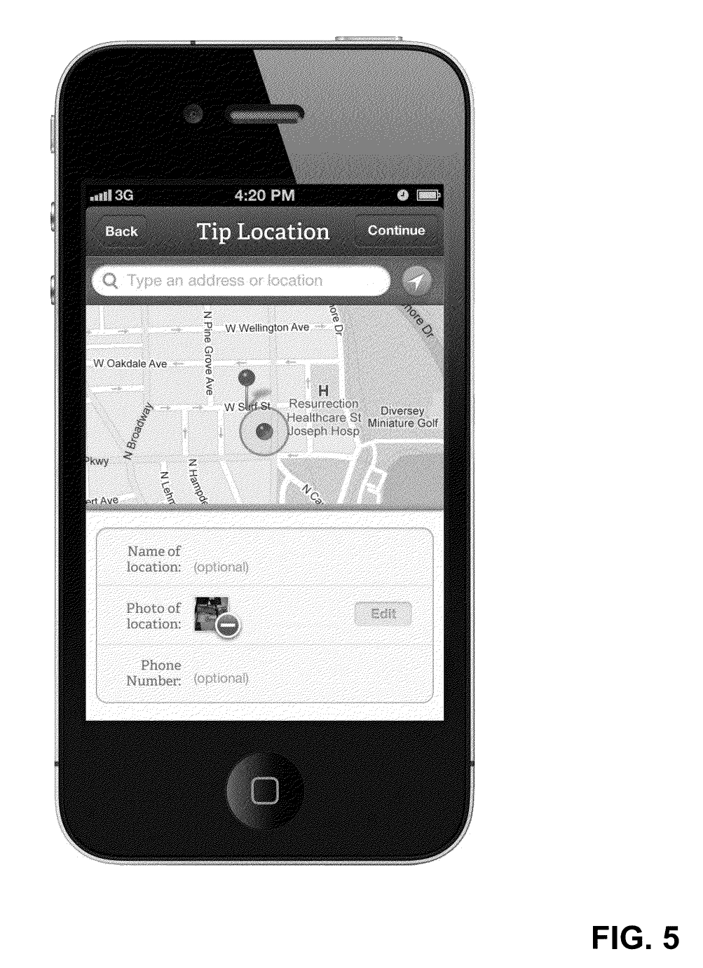

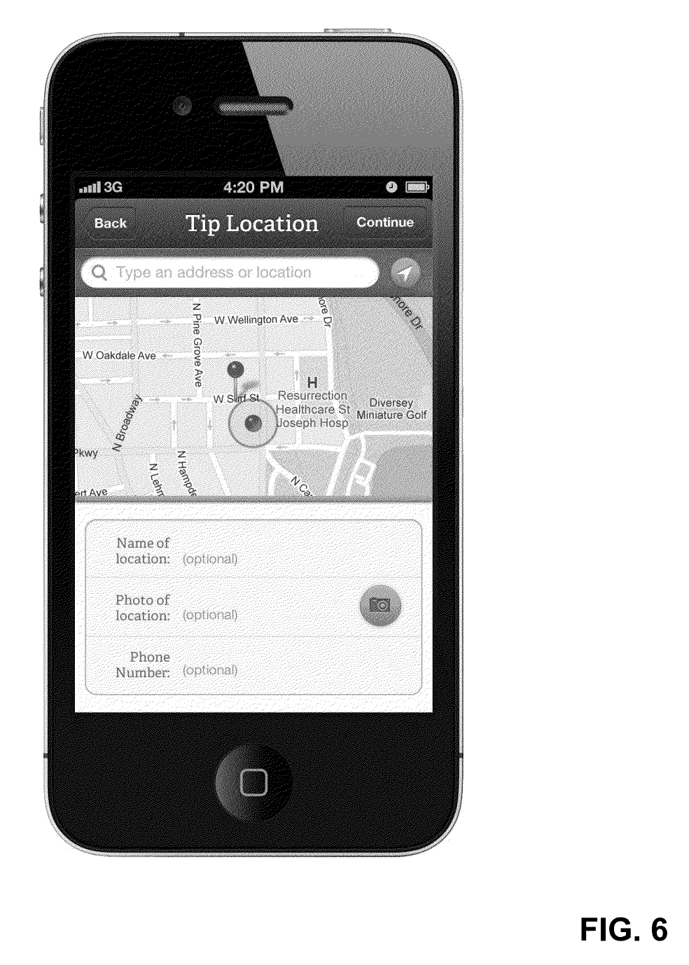

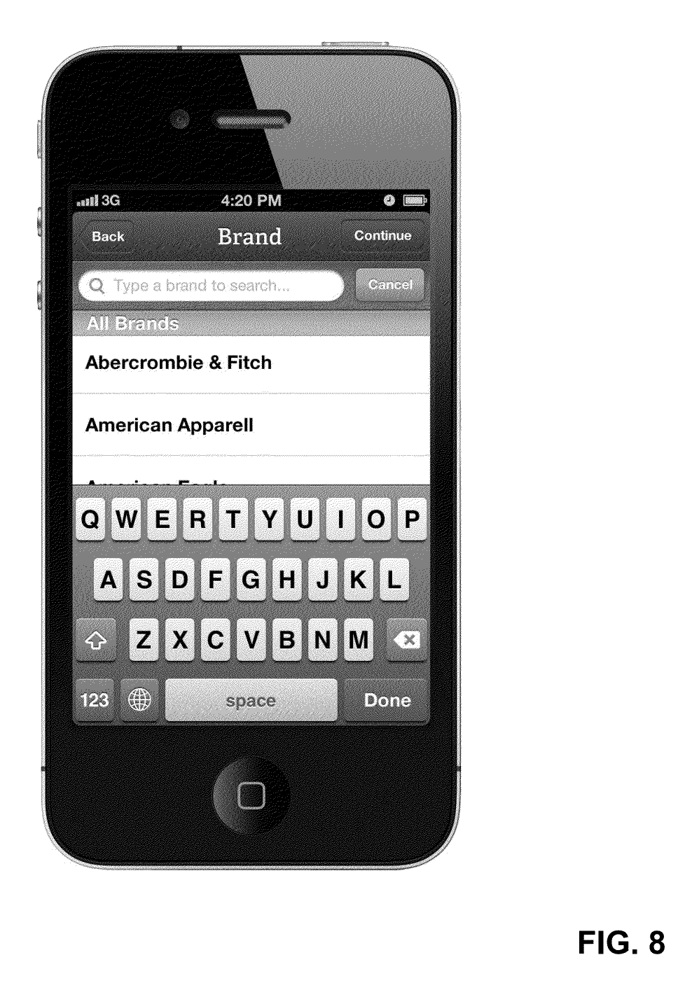

The following detailed description focuses on one specific embodiment of the inventive crowd sourcing method. In this embodiment, a mobile smart phone application utilizes crowd sourcing to locate, identify and report goods and/or services that infringe upon the intellectual property rights of an entity. In particular, this embodiment is designed to focus on counterfeit goods that may be available to consumers. FIGS. 2-11 capture the application's ability to geo-locate and categorize suspected counterfeit goods. FIG. 1 also shows the feature included in the system whereby the “crowd” can photograph the potentially fraudulent product to include with the report. Reports of fraud may be incentivized by the brand owner in the form of cash rewards, prize bounties, game scores, or social media rewards. Those having ordinary skill in the art will realize how to apply the same or similar crowd sourcing methods to the other areas as described above. While the following description of the inventive method focuses on a user taking one or more photographs of the subject matter being reported, the method also includes the ability for a user to make audio or video recordings of the subject matter being reported.

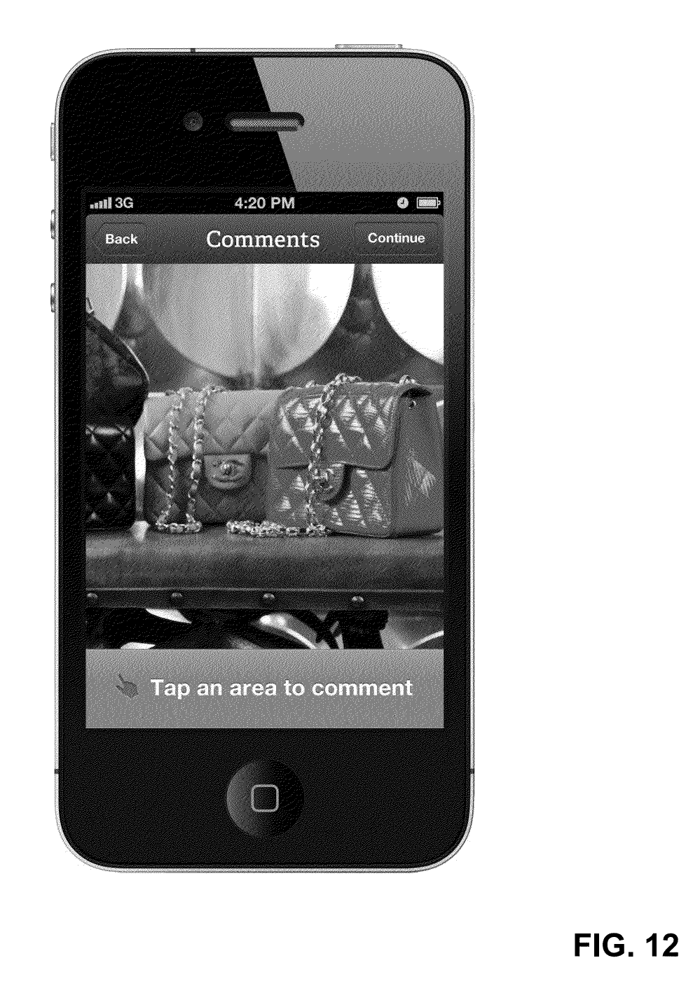

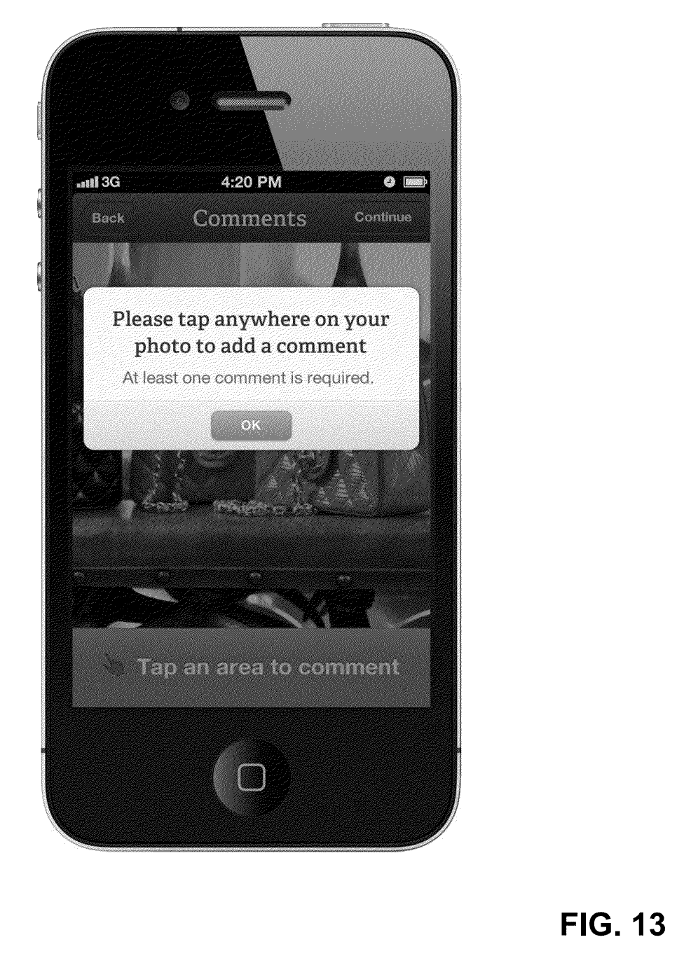

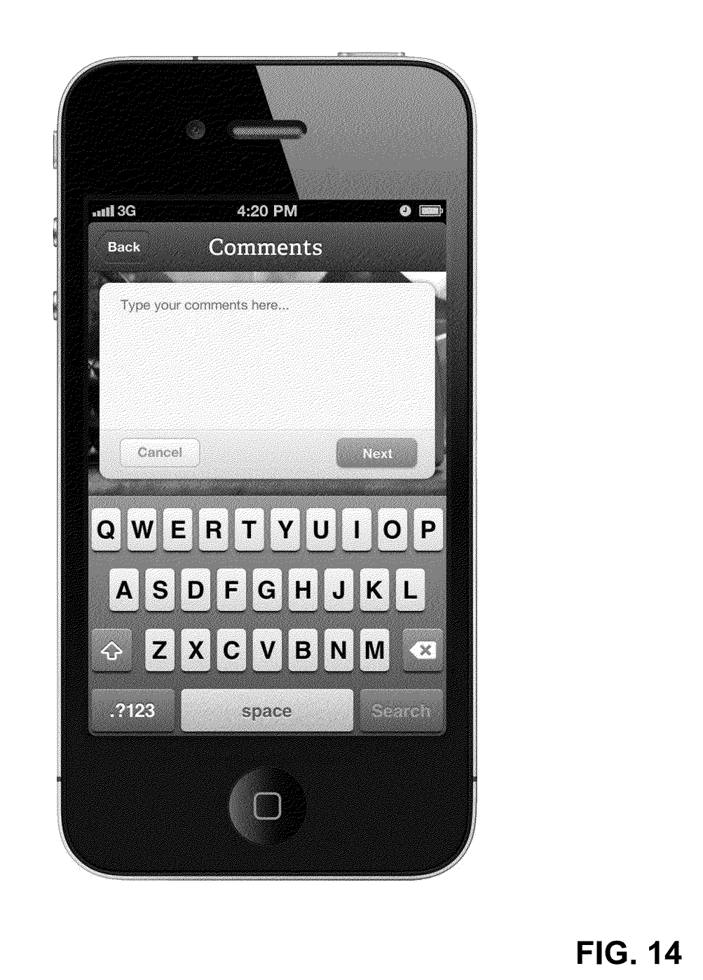

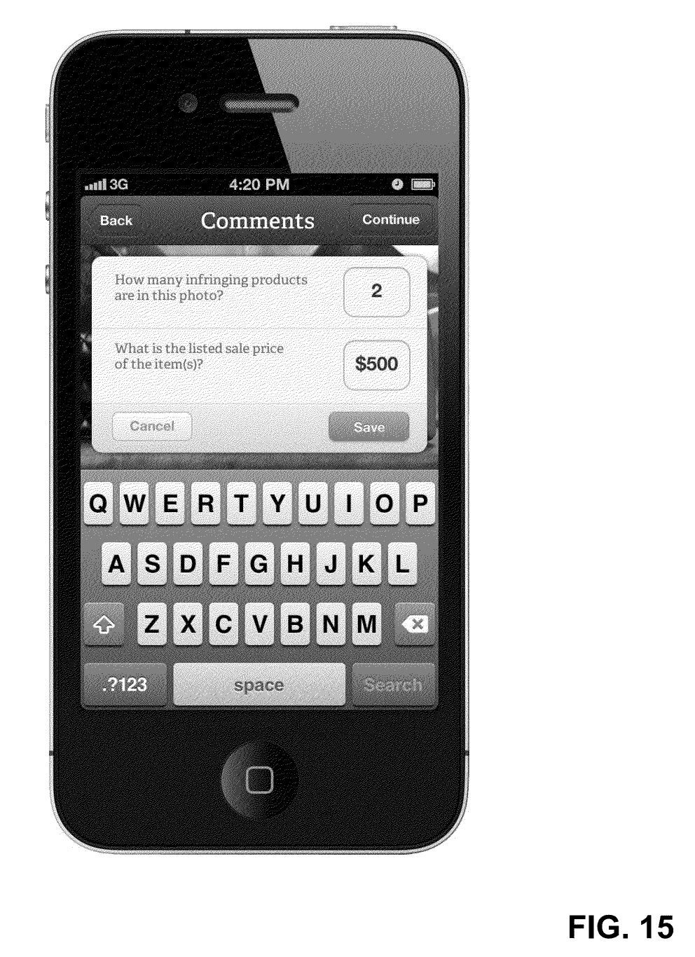

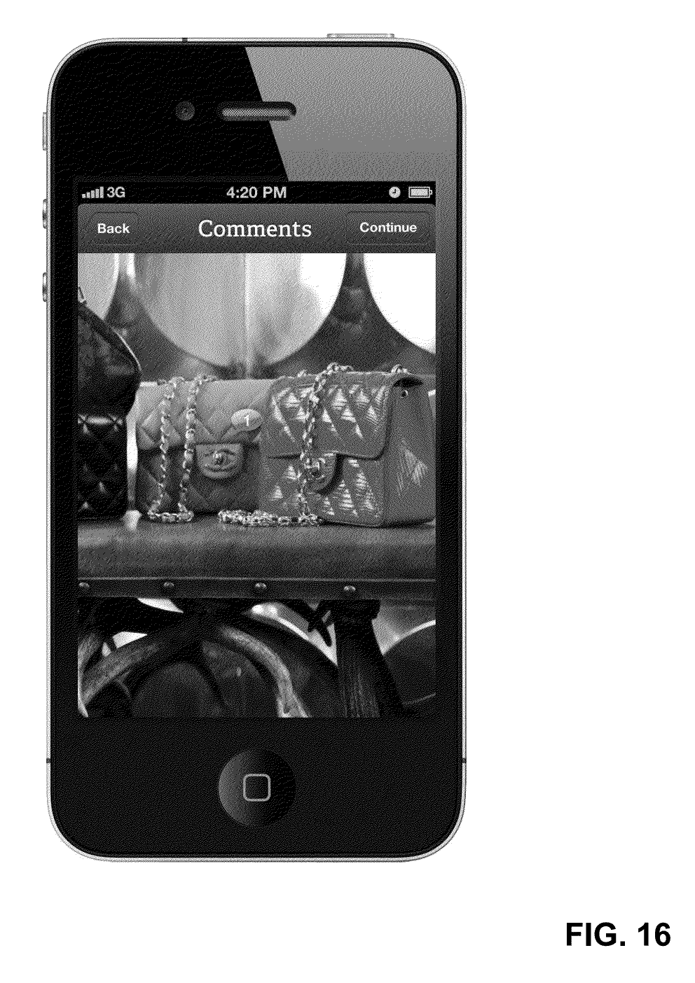

In a preferred embodiment of the current system, crowd sourcing is used to report and track intellectual property infringement. In this embodiment, a user reports a potentially fraudulent product via his smart phone. The smart phone application includes features that make it easy for a user to quickly create and submit these reports. First, the user initiates the process by using the mobile device's camera to scan a suspected counterfeit product's Barcode, QR code, BR code, or using the device's Near Field Communication technology to identify the product(s) (FIG. 1A). This may allow for instant identification of verified authentic or fraudulent products, and maintain a record of the product(s) in a database. Next, the user takes a photograph of the product with his smart phone as is shown in FIG. 1. The smart phone application allows the user to tag the photograph with comments regarding the price point for the product, number of products being sold at that location, as well as the address of the location where the products are being sold, and any other comments the user might have (See FIGS. 12-16). The smart phone application allows the user to access the smart phone's geo-locating capabilities for a pinpoint location, if the user is unsure of the address of the point of sale as in FIGS. 2-6. This information can automatically be included in the report as well. If the phone application is unable to automatically pinpoint the location of the report, the user can simply enter the address in manually. The application also permits a user to submit a photograph or other recording of the location, i.e., establishment, store front, etc.

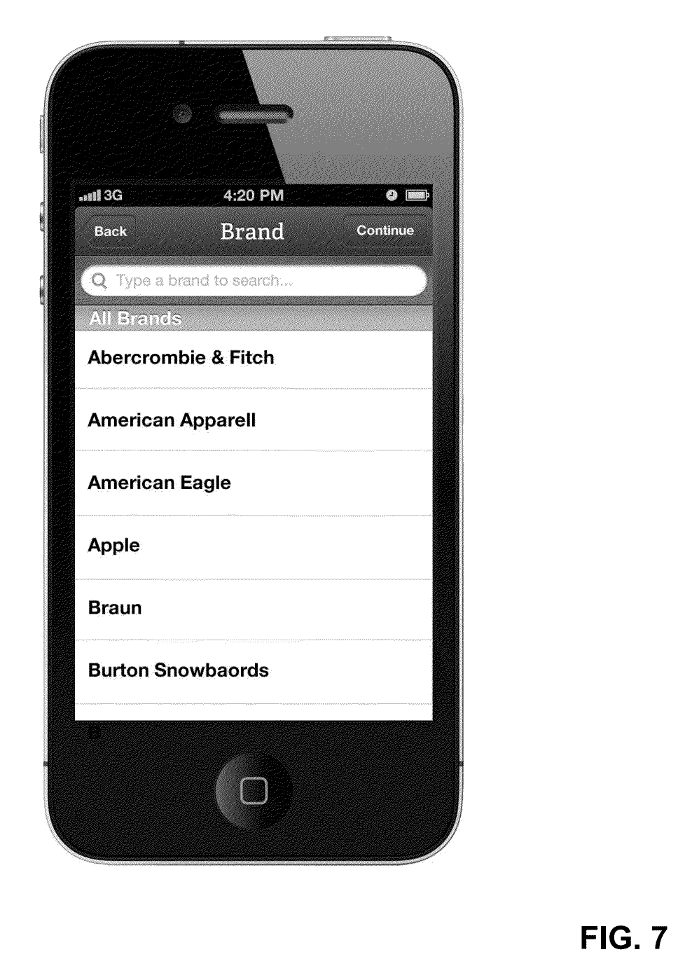

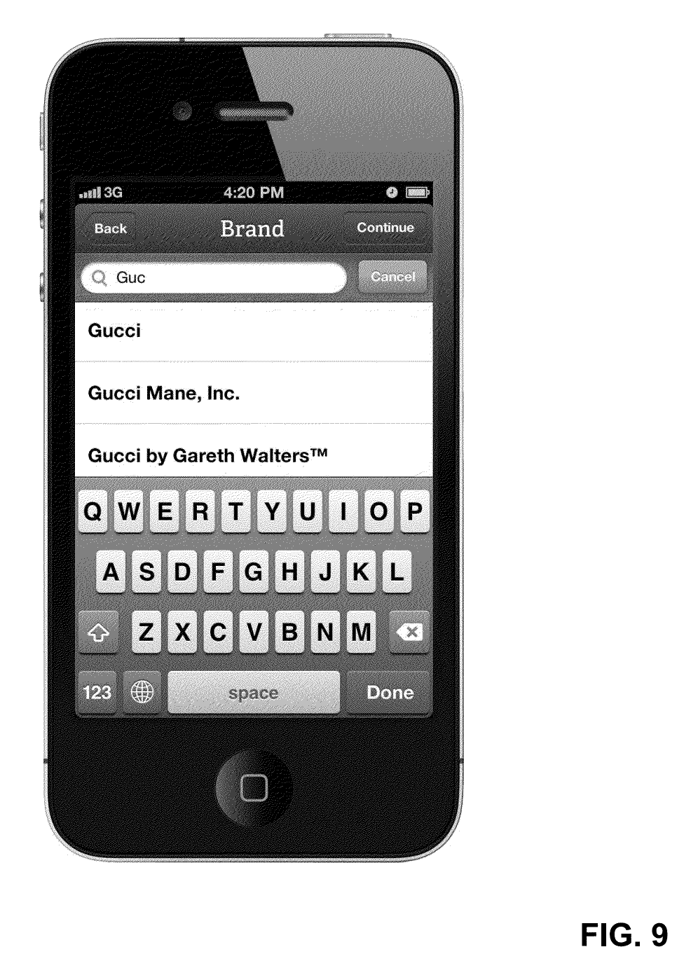

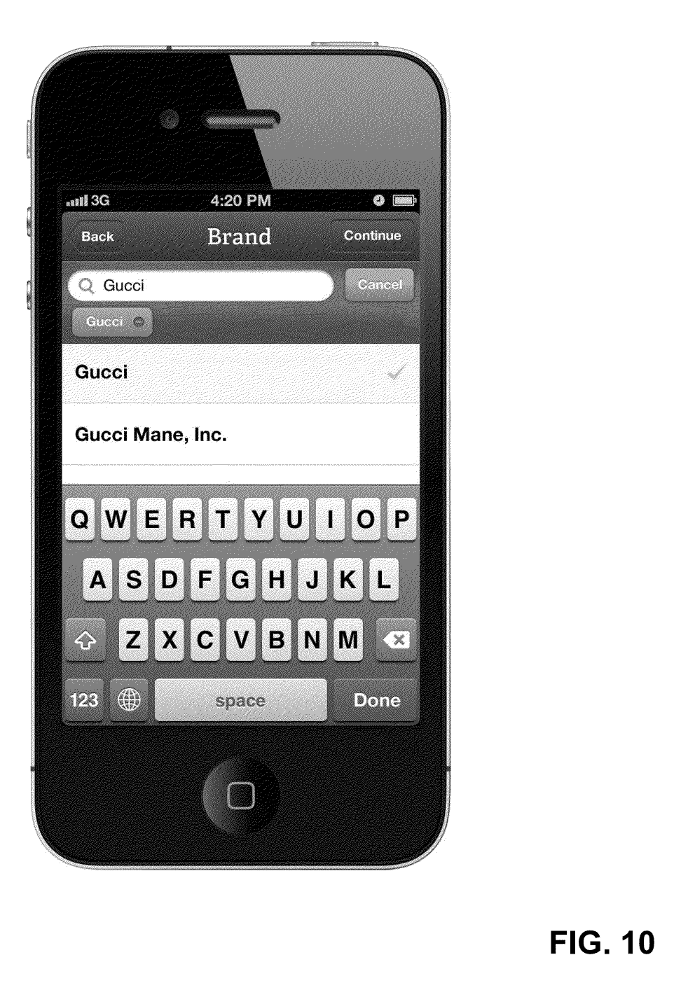

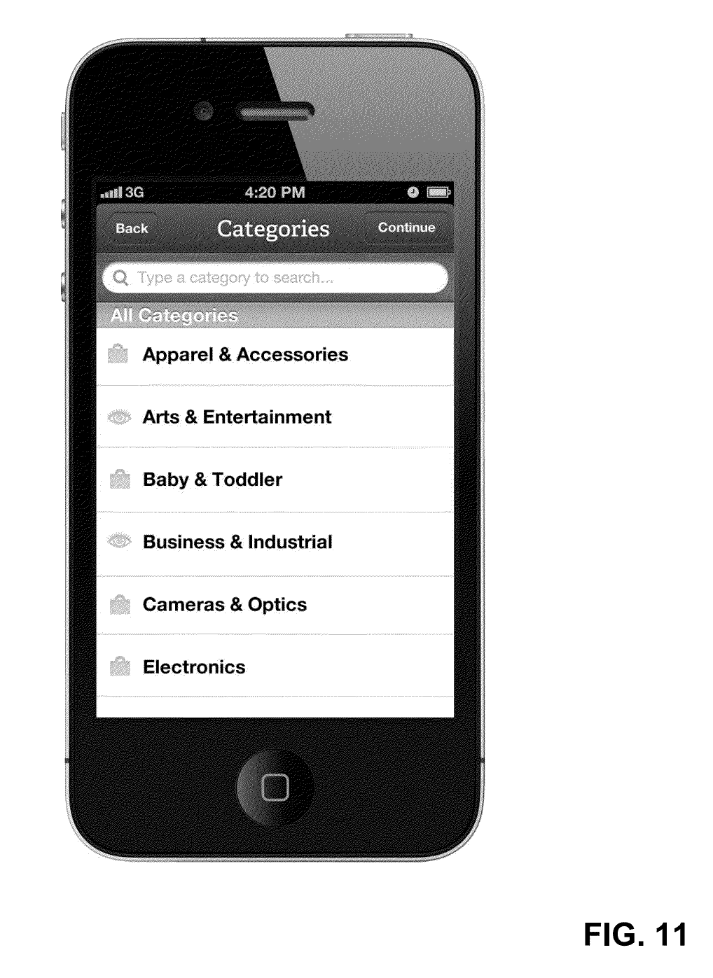

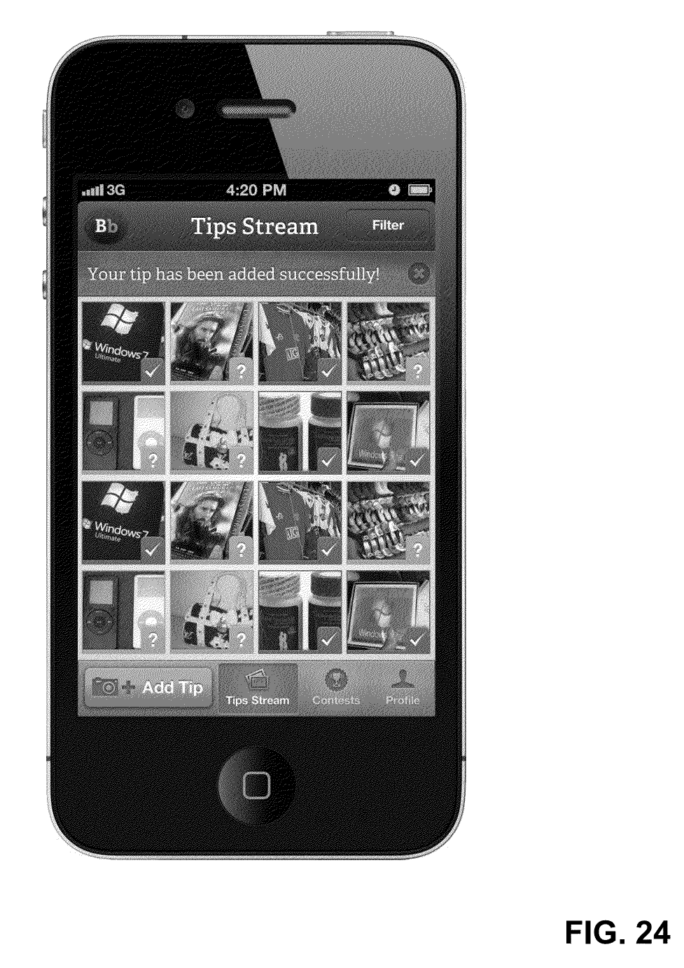

The smart phone application also allows the user to categorize the product. The process of associating a brand and product category with a report is shown in FIGS. 7-11. Available categories may include: apparel, electronics, leather goods, shoes, fragrances, motion pictures, etc. (See FIG. 11). The user can also choose a brand that is associated with the offending product. If the user has selected the category of “shoes”, available brands may include GUCCI®, CHANEL®, COACH®, PRADA®, etc. (See FIGS. 7-10). Alternately, the user can manually input the appropriate brand if the brand is not on the list. As the user starts to type in a brand name, the results list will automatically filter itself to match the entry being typed. (See FIGS. 9 and 10) The brand selection will affect how the finished report is submitted. The smart phone application also allows the user to add comments to the report and include contact information if (s)he is willing to come forward as a witness. Once all the necessary data has been provided by the user, the completed infringement report can be submitted (See FIG. 24). FIG. 24 also shows that the user can be provided with a list of other fraudulent product reports that have been reported. Pictures with a green check mark represent products that have been verified by the brand owner as being fraudulent. Pictures with a yellow question mark are unverified reports.

The completed report is submitted to the brand owner associated with the infringing counterfeit product. The brand owner can access a feature of the system to view trends in how these counterfeit products are being sold. For example, the brand owner can have all reports connected with a certain product (say a specific handbag) analyzed to show where the focus of the sales is. The brand owner may have a map produced where red dots show each sales location. From this map the brand owner may be able to more easily see where the sales are concentrated. Other report analysis functions can provide the brand owner with information related to typical price points for counterfeit goods, quality of the counterfeit goods, and quantity of counterfeit goods being sold. These reports can provide the brand owner with very valuable information as to how these counterfeit goods are getting to the market, as well as possible ways to track down the source of the counterfeit manufacturing.

Submitted reports are not limited to trademark infringement. A report can be submitted for suspected infringement of any type of intellectual property including: brands, patents, trademarks, copyrights, identity/publicity rights, music rights, jingles, works of art, photographs, unpaid royalties, etc. If the report is focused on infringement of a right that cannot be photographed (i.e. a popular song is being played without permission), the report can include an audio/video recording or simply a written description. In situations like these, the mobile application can include the ability to “listen” to the music and automatically try to match what is being heard to proprietary audio. The mobile application may also include the ability to incorporate videos as well as photographs and audio files in submitted reports.

The inventive system can also include functionality to automatically identify the proprietary property being infringed by the subject matter of the report. In implementing this functionality, the system first scans the submitted report, photograph, audio recording and/or video recording to with a type of image/sound recognition technology—think GOOGLE GOGGLES® or SHAZAM® software—to identify words, logos, patterns, sounds, or other property that is proprietary to a third party. The system may also take suggestions or guidance from the user submitting the report to more reliably identify the proprietary property. The suggestion or guidance may take the form of identification by the user that is then used as a reference when scanning the submission. Alternatively, the user may outright tag the report, photograph, audio recording and/or video recording to identify the subject matter being reported.

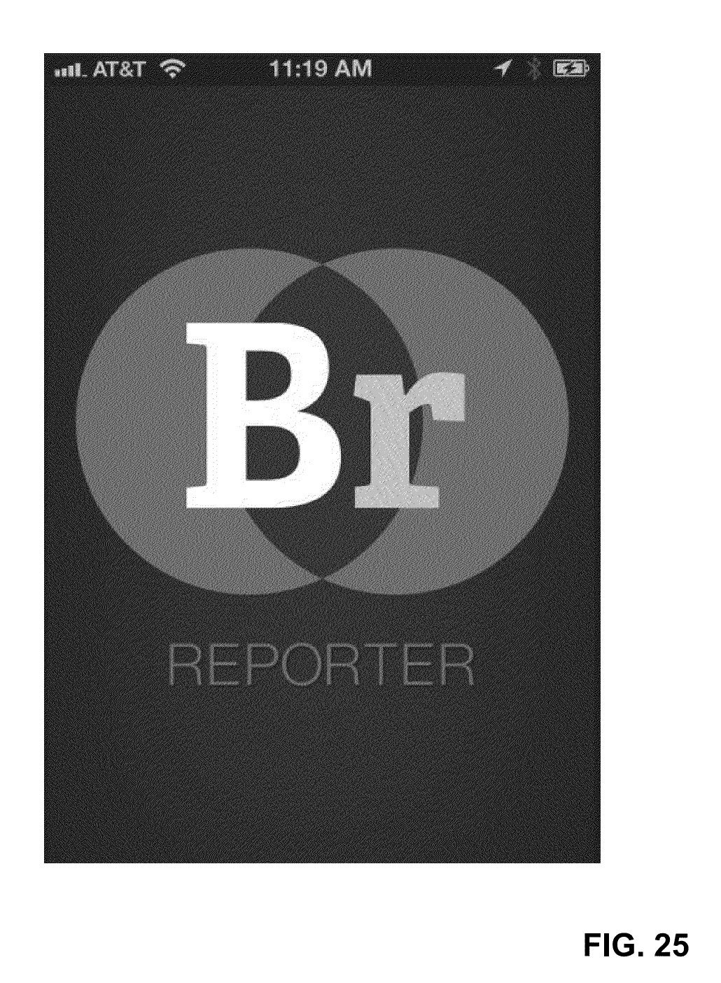

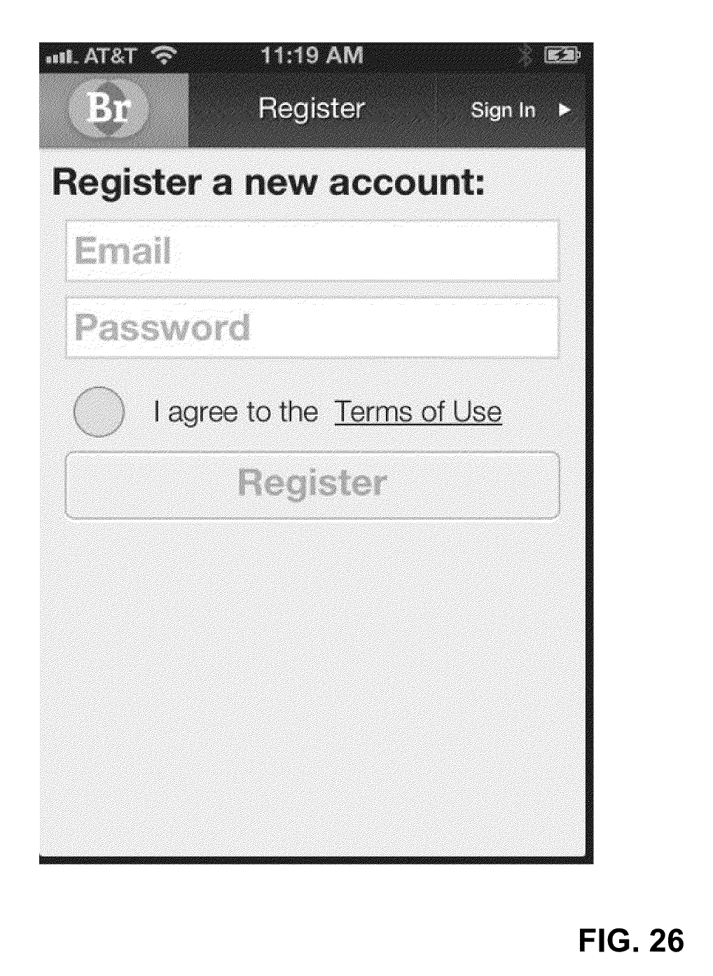

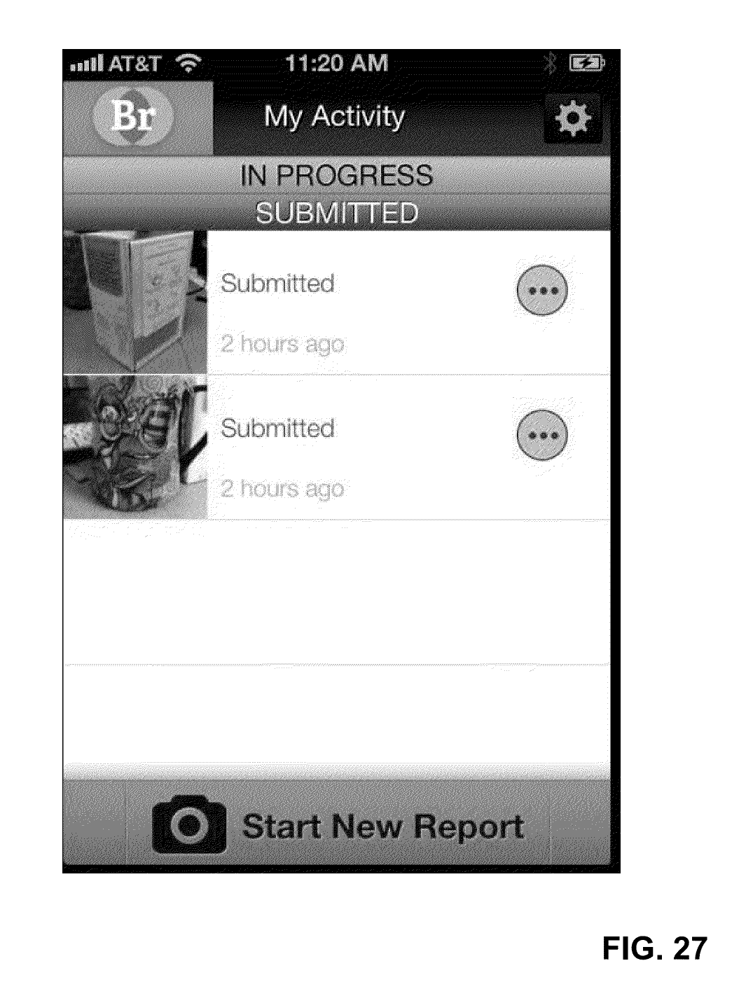

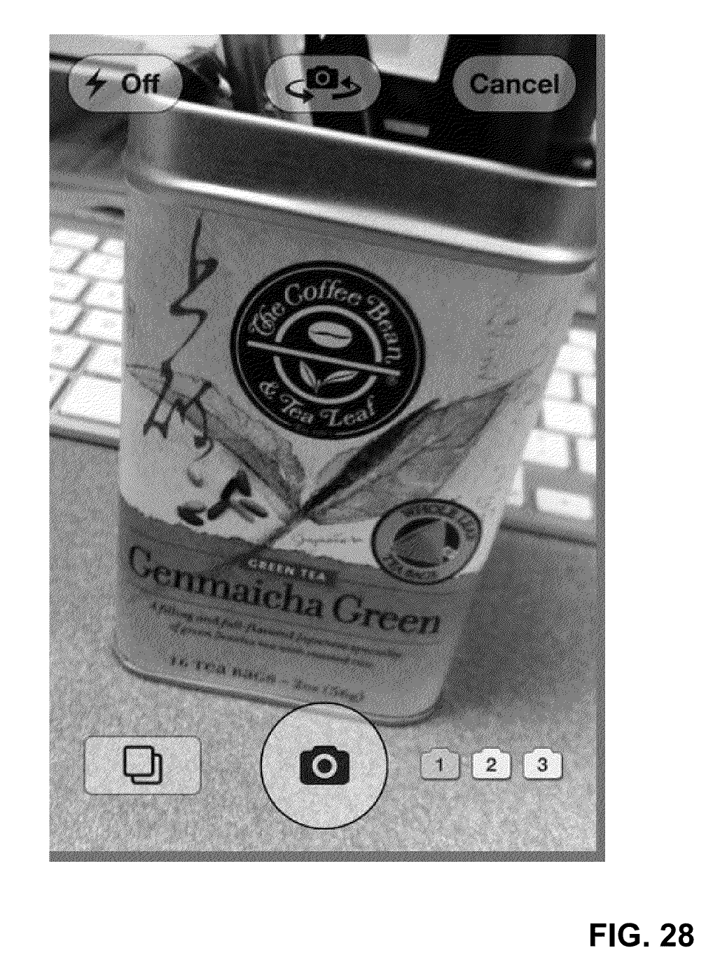

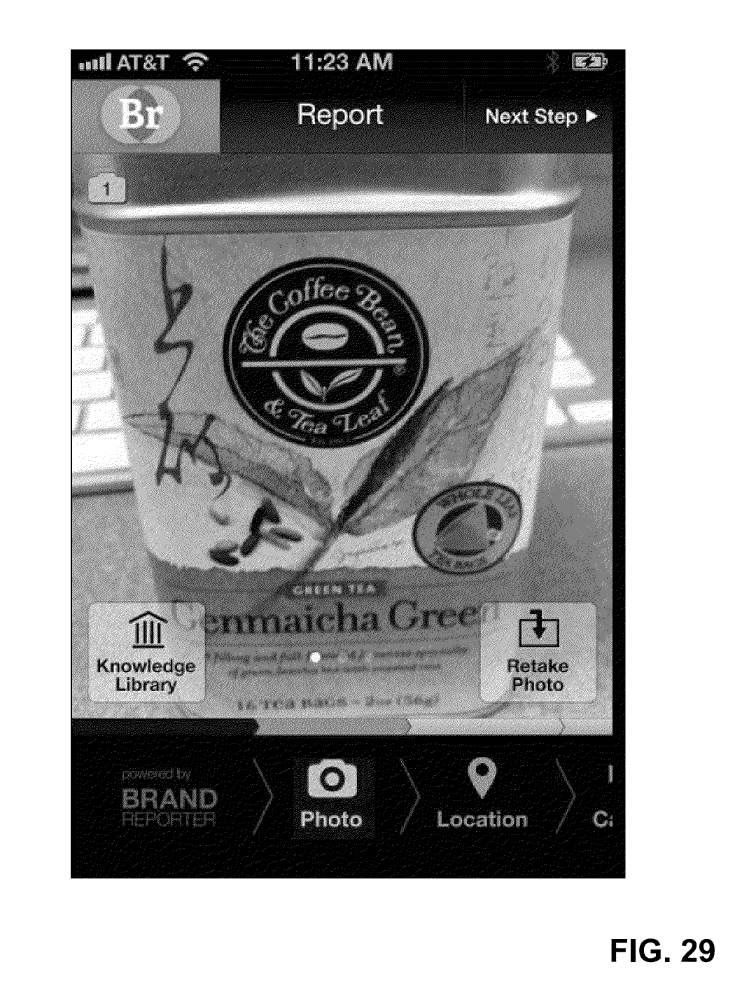

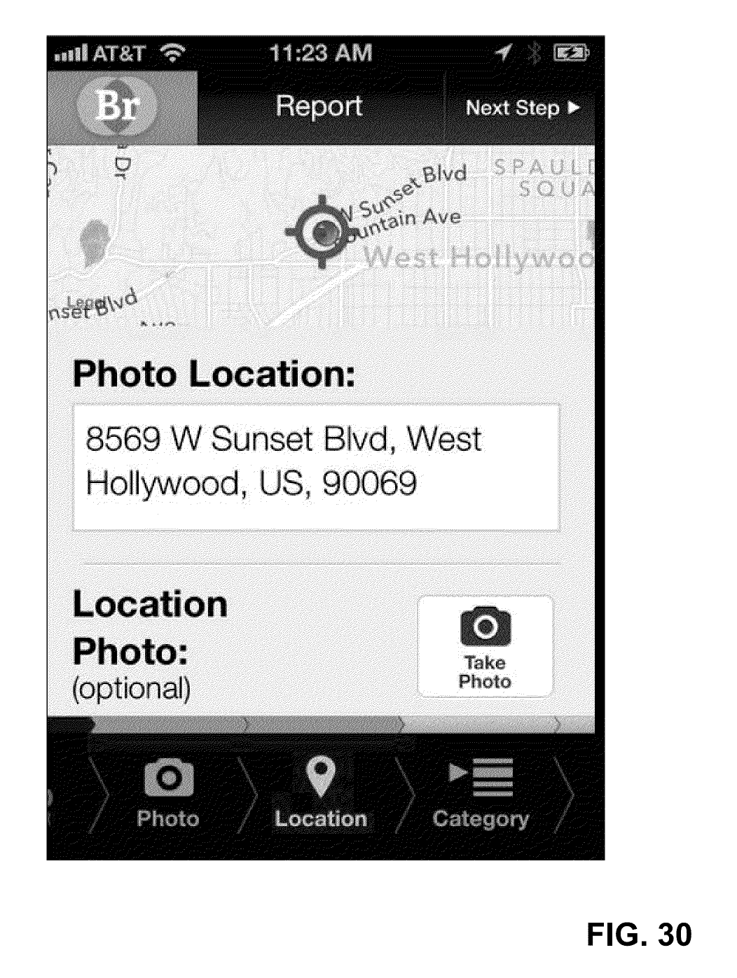

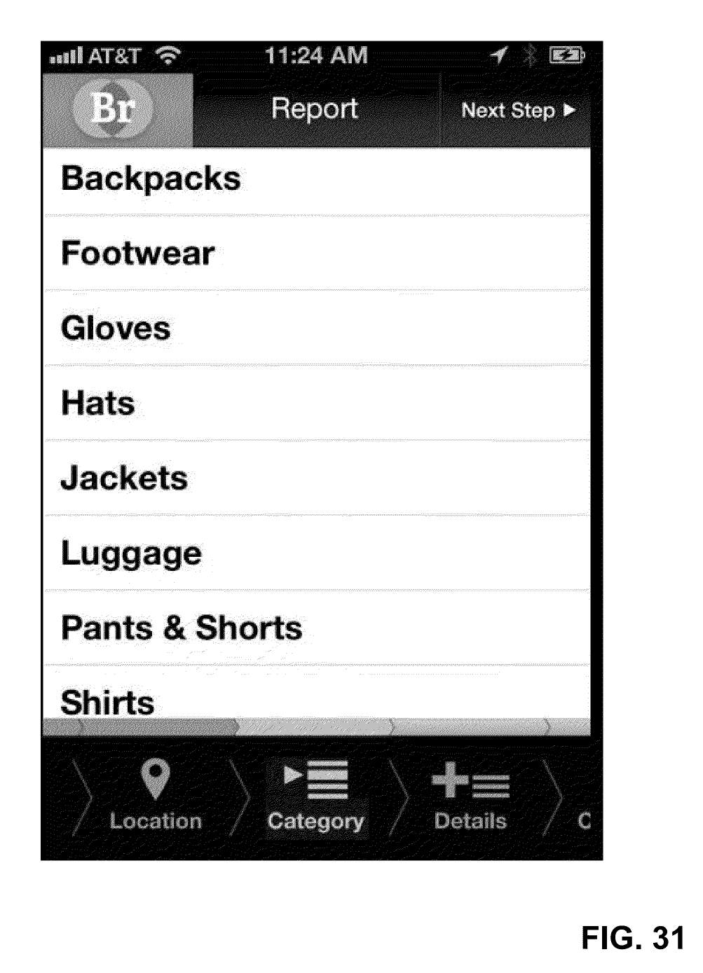

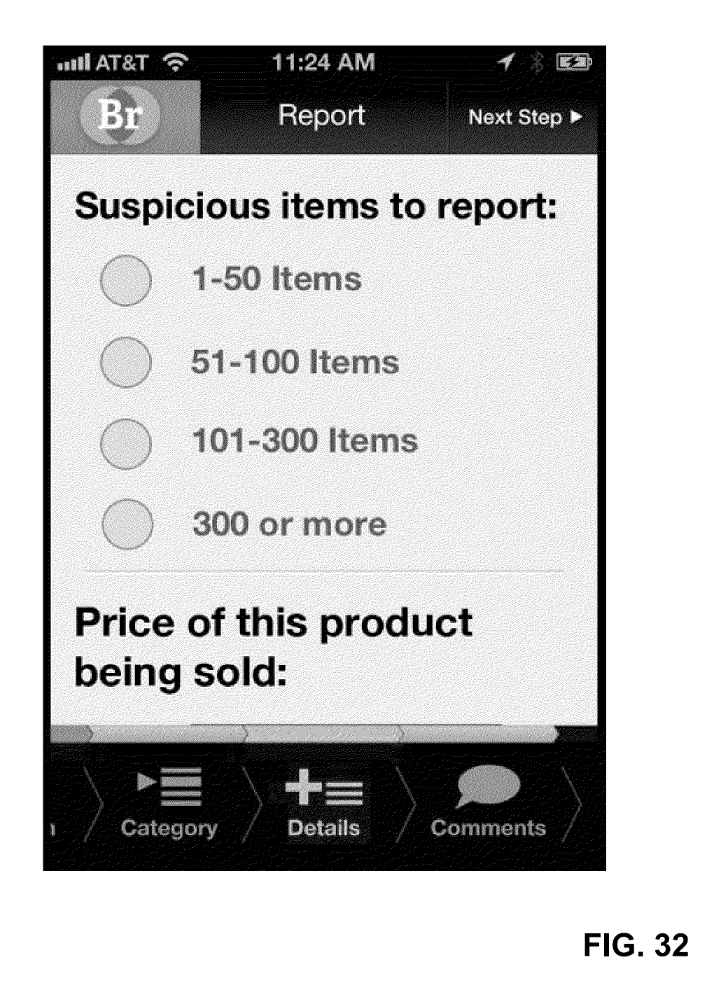

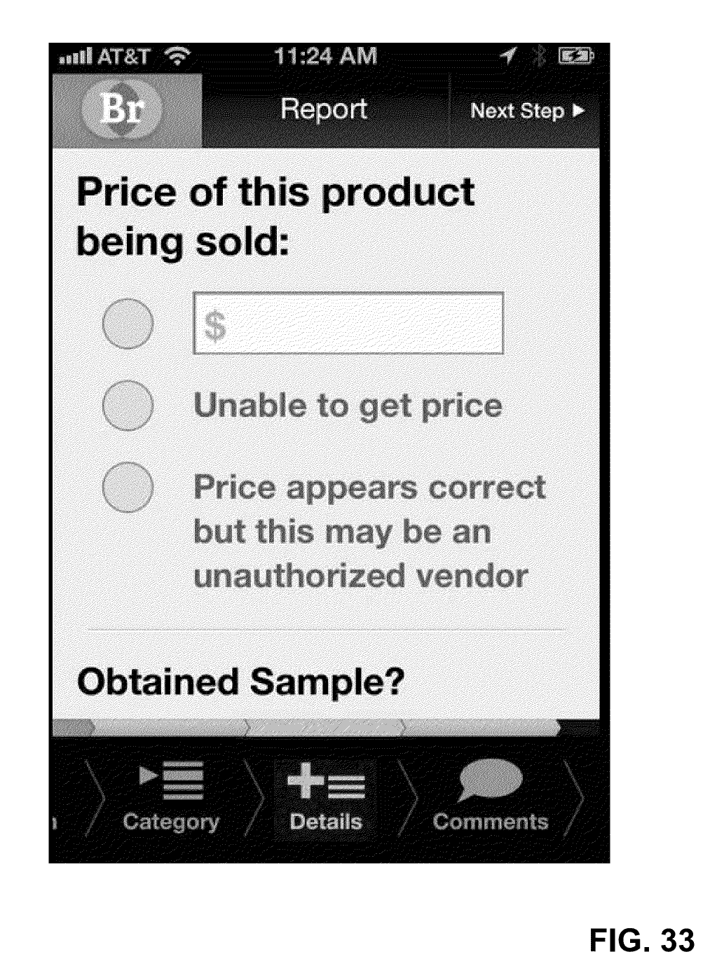

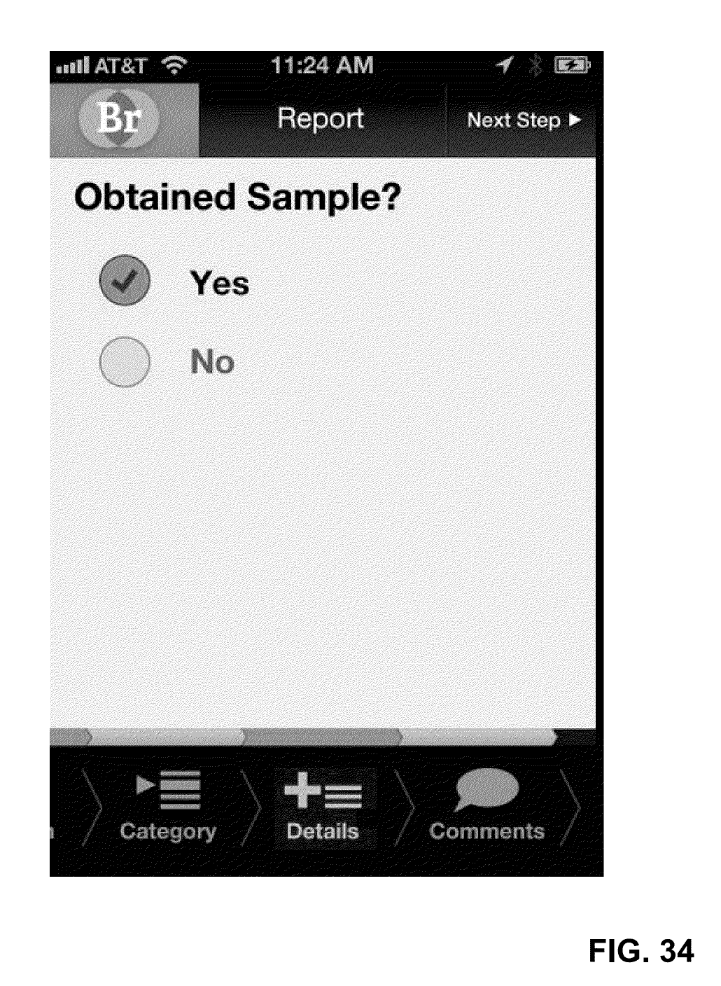

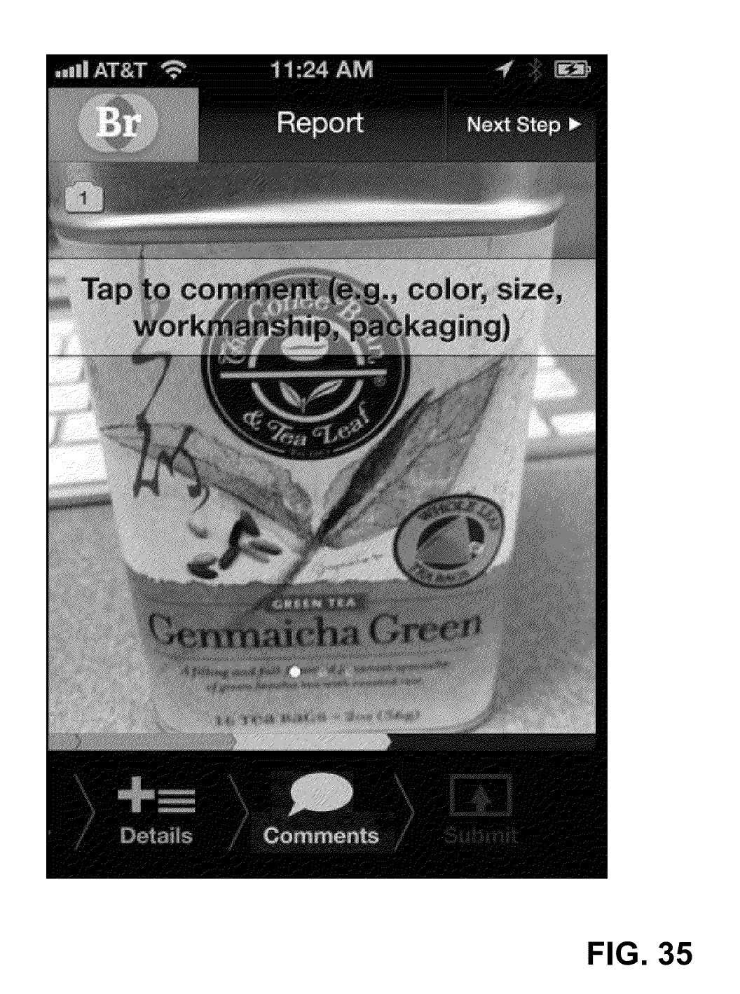

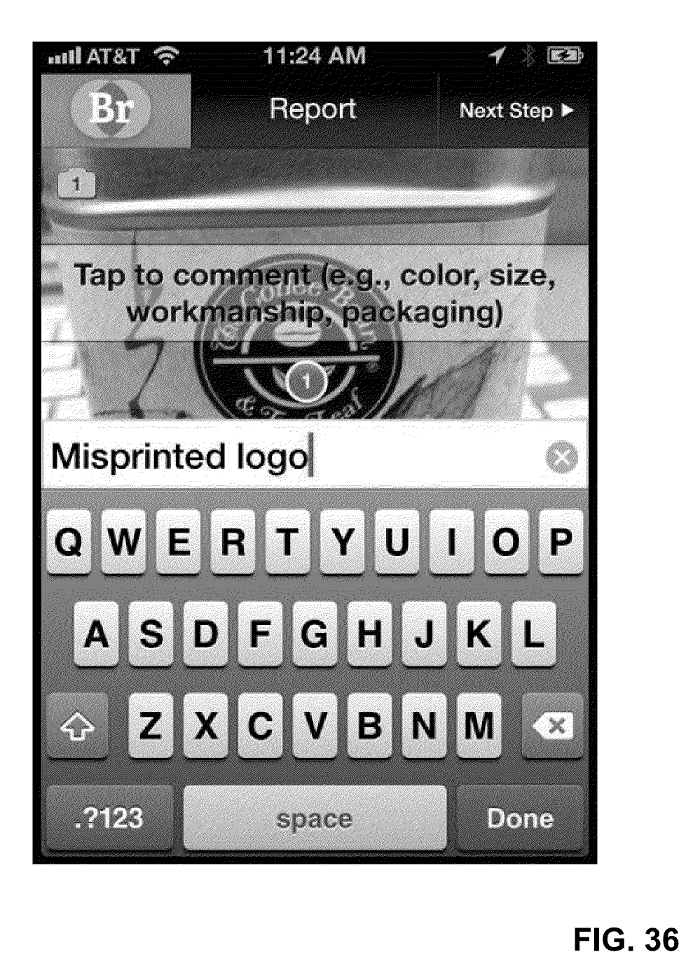

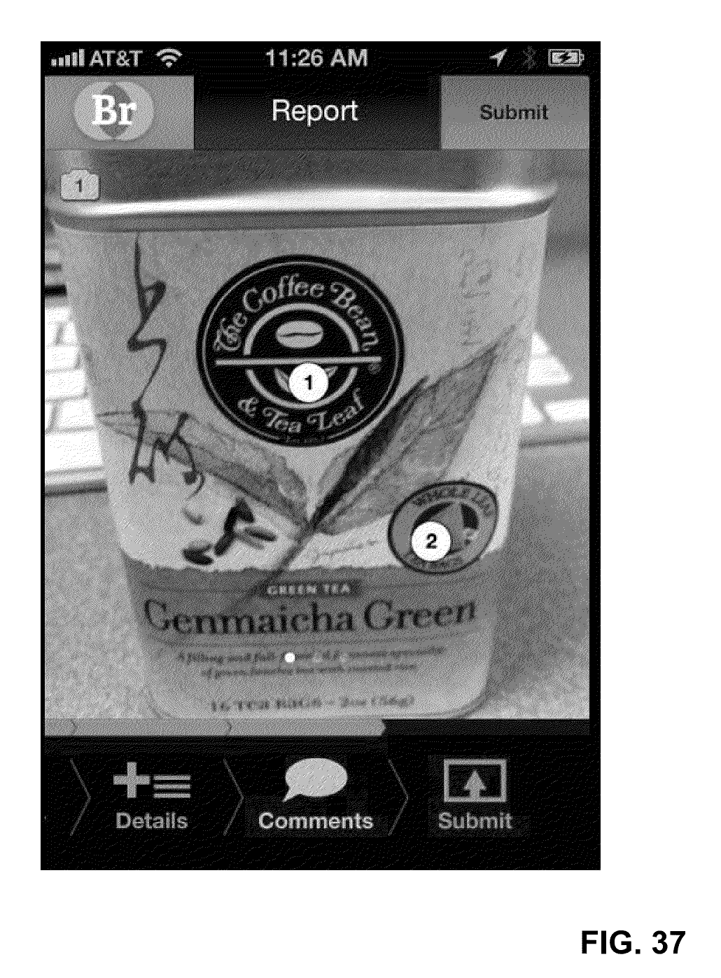

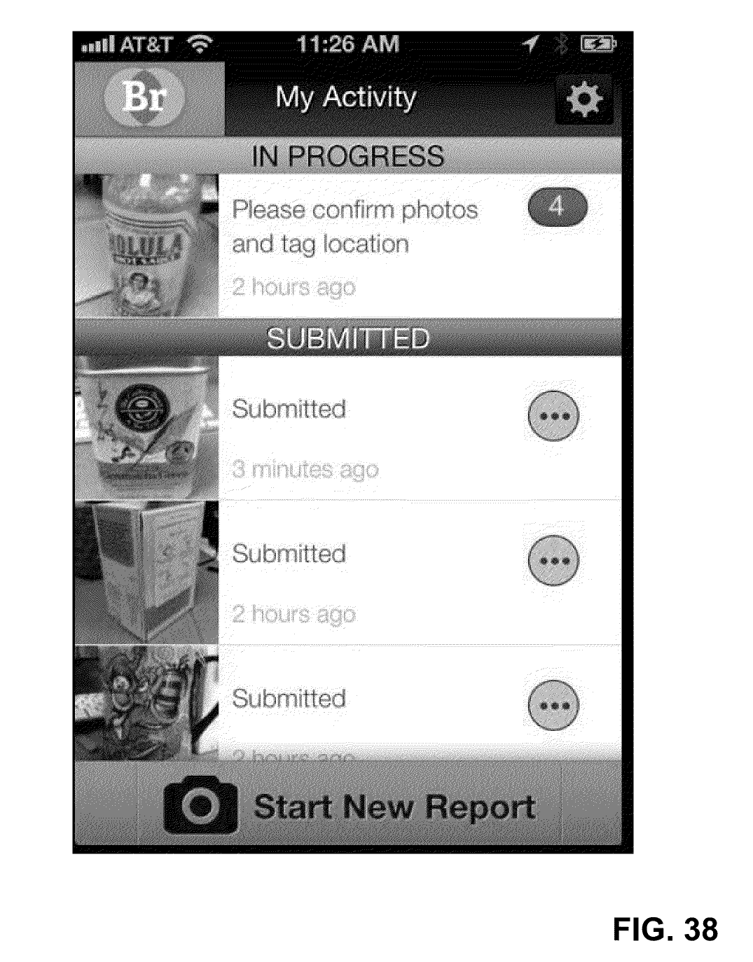

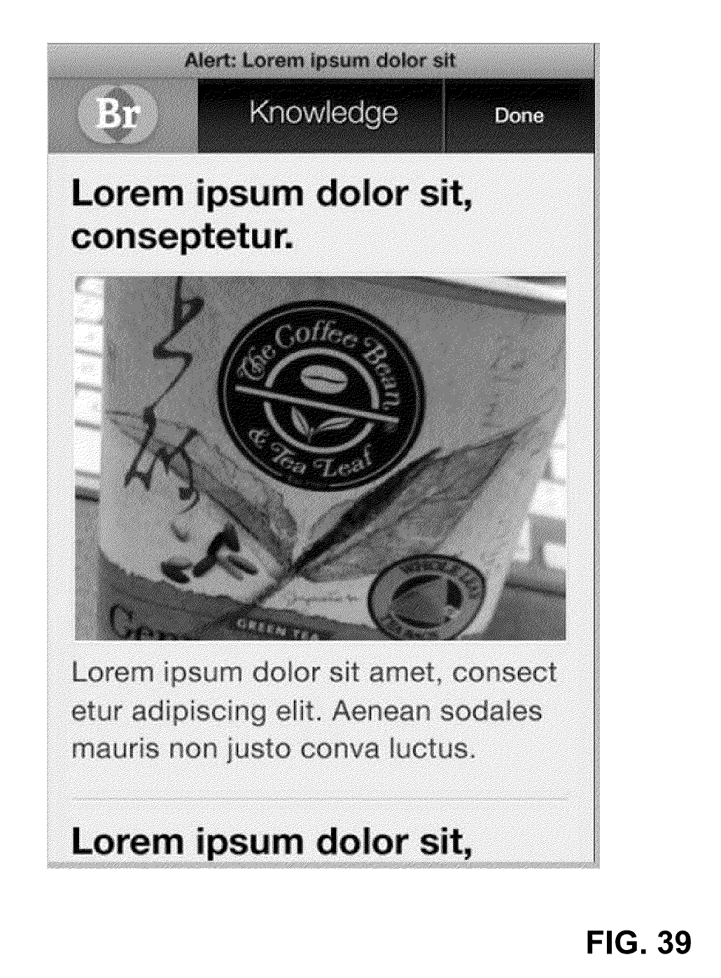

FIGS. 25-39 present screen captures of an alternate embodiment of the mobile application for the present invention. FIGS. 25 and 26 capture a title screen and user account registration screen. FIG. 27 captures a user activity page from the mobile application. FIG. 28 captures a photo grab page from the mobile application. FIGS. 29-37 capture reporting screens from the mobile application. FIG. 38 captures an updated user activity page from the mobile application. FIG. 39 captures a page from a knowledge library in the mobile application.

As QR code, BR code, NFC identification, photo and text information is passed from a user to the platform, i.e., mobile device application or other information intake entry points to server, and then to the centralized platform, the system may computationally process the submitted data to determine the accuracy of the information. The system uses a combination of factors to formulate an algorithm and produce an outcome that is adjusted depending upon the specific facts of each report. The algorithm combines data derived from the following areas, including, but not limited to, the user's reporting history, the user's reporting reliability, a social graph, the camera software, crowd source reviews, and brand review history.

The user's reporting history includes analyzing information about the user's previous submissions, the number of accurate tips submitted, and the actual information submitted by the user. The actual information submitted by the user may include price, sample obtained, location, or any other factors relevant to reporting a tip. Users' reporting reliability is a factor of the user's reporting history relating to the number of accurate tips submitted. Social graph refers to an analysis of data based upon social media and other similar factors. The graph may take into consideration public crowd, Facebook and Twitter data such as likes, shares, and postings. For a brand owner's internal work force, the graph may also consider department and expertise identification for a reporting user. Camera software includes analyzing data such as project label codes, tag numbers, measurements, frames and object dimensions. These may be compared to information maintained in a database of brand owner's goods or known counterfeit goods. See the knowledge library discussed below. Crowd source review analyzes data including information regarding the quality of the photos and the subject matter of the photos. Brand review history analyzes data including each brand's historical review of similarly reported items.

The user can be incentivized to submit reports of counterfeit goods in any one of a number of ways. First, the brand owners can advertise their need for reports on certain counterfeit products. As part of the advertisement, the brand owner can offer a prize “bounty”, i.e., cash, goods, coupons, etc., for information leading to the successful seizure of counterfeit goods. The advertisement can be offered through the smart phone application where registered reporters are notified of each new bounty as it becomes available across a spectrum of brand owners. Brand owners can also list their bounties on their business websites, emails, and advertisements and advise that reporters use the present invention to submit reports. A bounty can be made to each successful reporter, or can be shared among a group of successful reporters.

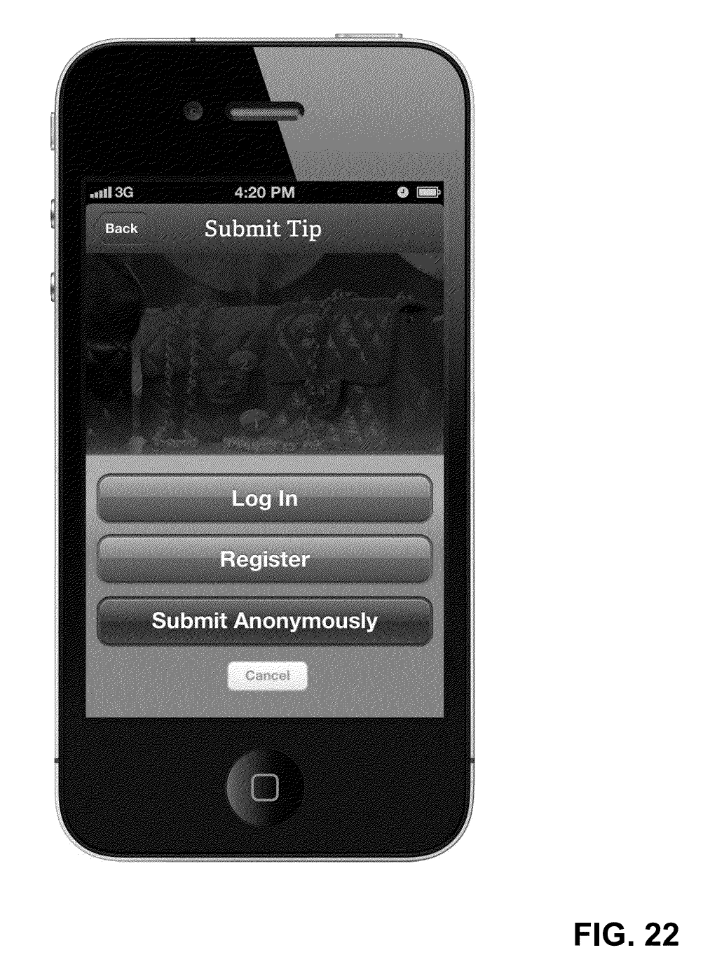

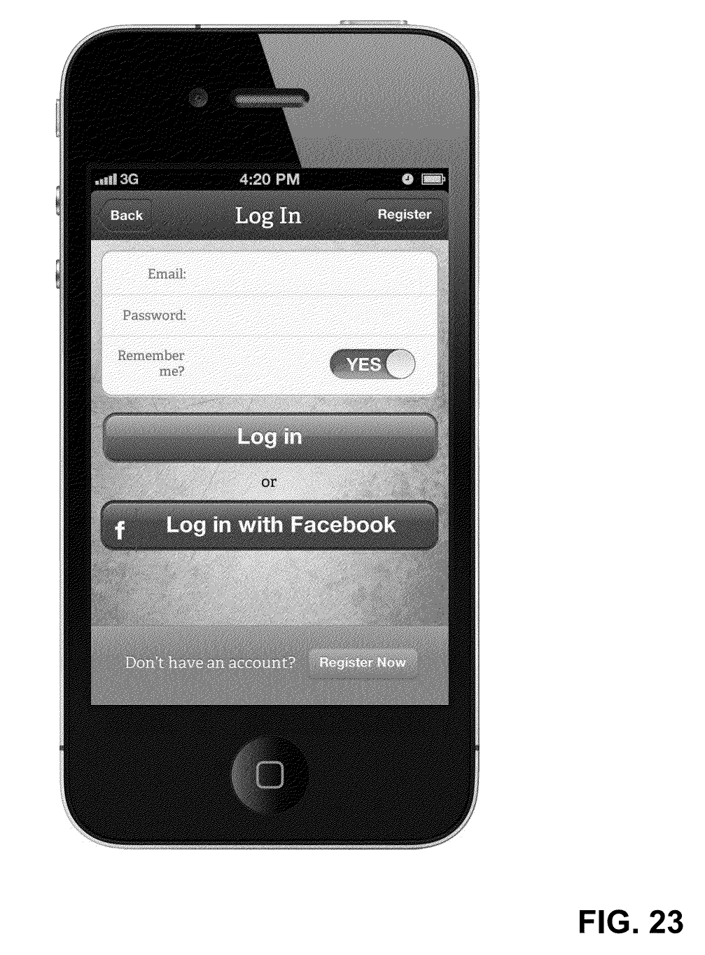

Application users can either use the application under their registered user name, or they can submit reports anonymously. (See FIG. 22) If the user is submitting a report under a registered username, the accuracy and strength of his reports can be used to create a user score for that user. Brand owners can reward application users with increased bounties or other prizes. FIG. 23 shows that a user can log in to the application with an email address and password. Alternately, the user can log in through a social networking platform, i.e., FACEBOOK®, TWITTER®, GOOGLE®, PINTEREST®, OPENID®, etc. If the user chooses this option, his social networking status can automatically be updated with a status like, “John Doe just submitted a report on a fraudulent GUCCI® bag!”, or the like. Other users may have the option of following certain users through the application, such as to follow certain user that frequently submit reports or otherwise hold interest for another user.

Reporters can also be incentivized via a game model. Online gaming is very popular, and groups of friends can win points, badges, or other tokens as they complete tasks over the course of the game. In the current system, a reporter may win a certain amount of points for submitting a report. He may then win additional points if his report leads to the successful seizure of counterfeit goods. As the reporter acquires more points, he may receive honors within the game that set him apart from his friends. The current system can also work in conjunction with social media such as FACEBOOK®, TWITTER®, FOURSQUARE®, etc. For example, when a reporter successfully submits a report, his FACEBOOK® status can automatically be updated to read, “John Doe just reported a counterfeit GUCCI® handbag in New York City!” or the like.

Another incentive that can be offered to reporters is the opportunity to increase their personal score within the system. For example, as a reporter provides consistently valuable reports in a given area over time, his reporter score will increase. This may mean that reports received by brand owners from reporters with high reporting scores are taken more seriously.

Brand owners may even offer a higher bounty to reporters with higher scores as a way to increase their amount of trustworthy reports for a given product. Similarly, the brand owner can be assigned a score based on how many reports he requests and how often he awards a bounty or prize for submitted reports. In this way, the reporter can gauge how much time he wants to spend in providing the brand owner with information.

An application user may also be incentivized to complete each report through a mobile application to receive either online or offline commerce opportunities. When a user completes a report the platform may output similar product information based upon the product information contained in the submission reported by the user. This output of similar product information is sent directly to the user within the application for purchase. The output of similar product information may identify goods related to those just reported by the user as a marketing opportunity, believing that the user is likely interested in purchasing those types of goods.

For offline commerce, the platform may determine the user's physical location and identify the nearest authorized retail store selling products from the brand owner for the recently-submitted report. The reported product information may include discounts, as authorized by each brand owner, and provide a coupon code within the application. The system will track redemption of the coupon when it is used at an authorized retail store. The platform may pass on the redemption information to the brand owner, but is not itself involved in the buying, selling or inventory control processes. For online commerce, the platform may direct the user to a transactional page within the application to permit the purchase of the brand owner's products, including the discounts as may be authorized by the brand owner. The platform may also perform credit card transactions and pass on the purchase order to the brand owner, but is not itself involved in the buying, selling or inventory control processes.

The inventive method of crowd sourcing may be limited to a white-labeling of the technological platform for internal use by a company. The company may tailor the platform to its own needs and property so as to specify that company's particular rights to be protected. The company may distribute the platform to their employees internally, such as to a sales force or other customer contacts so as to streamline tip submissions they may receive. The company's sales force may already have a system set up to receive tips from consumers, police departments or other law enforcement, and their own legal department. The technological platform can be adapted to accept and input these tips so that the company may better manage and analyze the same.

The platform may also be used to transmit information such as barcode, QR codes, BR codes, NFC identification information, photos, text and video to different users to smart phones or other web-enabled devices. The brand owner may use the platform to transmit one set of distinct information to its sales force and another set of distinct information to the public at the same time. These sets of information can be retrieved from a knowledge library located on the smartphone application or other web-enabled devices. The sets of information can include any text, photo, or video specific to the brand or group. For example, a brand may use the set of distinct information sent to its sales force to identify items that are on a high priority list to look for infringement and/or counterfeiting. The other set of data sent to the public may be used to identify the company's latest packaging or brand information to educate and bring awareness to the public. The brand owner may also identify known counterfeiters and their products so that the public knows what to look for to identify such counterfeiters.

The mobile application may also include a mechanism to transmit real-time information—a knowledge ticker—to a user. A ticker bar or crawl may present real-time text information on any subject matter that is indicated as being important through the platform. Information transmitted to the user will be based on real-time information initially submitted by such user. It is similar to a direct-connect walkie talkie between a smart phone and the platform. This can give a brand owner real-time feedback and guidance when a suspect good is located in the marketplace. The knowledge ticker may also appear as a push alert or other type of notification that is known to exist in web-enabled mobile devices.

The present system can also be utilized in other embodiments that do not rely on a smart phone application. For example, another preferred embodiment utilizes a website wherein a brand owner submits a “call to action” and advertises for reports regarding to fraudulent use of protected intellectual property. These advertisements can be read by registered users of the website, or an email containing the information can automatically be sent to all registered users. When a user has a report to submit, in the form of an email, or by filling out a web form on the website.

Another preferred embodiment includes the use of an automated phone line, wherein a caller is automatically prompted to submit information regarding intellectual property owners who are currently seeking reports. The information prompts would be for the same information that would be submitted via the mobile phone application or website, as described above. The collected responses are stored on a server, collated, and analyzed so as to produce a coherent report for the intellectual property owner.

Although several embodiments have been described in detail for purposes of illustration, various modifications may be made without departing from the scope and spirit of the invention. Accordingly, the invention is not to be limited, except as by the appended claims.

What is claimed is:

1. A process for crowd-sourced completion of one or more investigative tasks, comprising the steps of:
registering a plurality of users in a database on a centralized platform;
providing a software application to each of users, wherein the software application generates a report including information pertaining to the one or more investigative tasks;
receiving on a system server separate reports from two or more of the users;
uploading the separate reports from the system server to the database on the centralized platform; and
reviewing and analyzing multiple received reports related to a single investigative task to identify trends.

2. The process of claim 1, wherein the investigative task relates to investigation of IP rights held by a rights owner.

3. The process of claim 2, wherein the report includes identification of the IP rights, the rights owner, a known or suspected infringement of the IP rights, and a location of the known or suspected infringement.

4. The process of claim 2, wherein the investigative task relates to infringement of the IP rights.

5. The process of claim 4, wherein the identified trends in the multiple received reports relate to the IP rights, the rights owner, an identifiable source of infringement, particular commercial products, consumer price points, or a location.

6. The process of claim 2, further comprising the step of forwarding the multiple received reports related to the single investigative task to the rights owner along with the analysis of the same.

7. The process of claim 2, wherein the IP rights include patents, trademarks, copyrights, brand names, identity rights, publicity rights, music rights, jingle rights, artwork, photographs, or royalty reporting.

8. The process of claim 2, further comprising the step of transmitting information regarding genuine IP rights from the rights owner to the users through the software application.

9. The process of claims 8, further comprising the step of assigning a specific research task for particular IP rights to the users relating to the genuine IP rights information.

10. The process of claim 2, further comprising the step of transmitting information about known or suspected infringement of the IP rights from the rights owner to the users through the software application.

11. The process of claims 10, further comprising the step of assigning a specific research task for particular IP rights to the users relating to the known or suspected infringement of the IP rights.

12. The process of claim 1, wherein the software application is installed on a mobile computing device.

13. The process of claim 1, wherein the information pertaining to the one or more investigative tasks includes location, identification, and results of the one or more investigative tasks.

14. The process of claim 13, wherein location includes specification of geolocation, residential location, or business location.

15. The process of claim 13, wherein identification includes specification by list, category, photograph, or audio/video recording.

16. The process of claim 15, wherein the audio/video recording includes a listen feature whereby the software application matches the audio/video recording to a similar known recording.

17. The process of claim 1, further comprising the step of incentivizing the users to perform the one or more investigative tasks, wherein incentives include a cash reward, a prize bounty, or a game score.

18. The process of claim 17, wherein the incentives are tiered based upon a user rating.

19. The process of claim 17, wherein the prize bounty includes an online commerce opportunity or an offline commerce opportunity related to the one or more investigative tasks.

20. The process of claim 19, wherein the offline commerce opportunity uses geolocation retail proximity to offer discount or coupon codes usable in a retail location.

21. The process of claim 1, including the step of rating each of the users based upon the analysis of the reviewed reports.

22. The process of claim 21, wherein the analysis of the received report uses an algorithm that considers the users' reporting histories, the users' reporting reliability, a social graph for the users, crowd-source reviews, and brand review history.
